(19) United States
(12) Patent Application Publication
(10) Pub. No.: US 2023/0183112 A1
(43) Pub. Date: Jun. 15, 2023

(54) CONCURRENT RAW AND AERATED WASTEWATER TREATMENT METHOD USING BIOELECTROCHEMICAL SYSTEM

(71) Applicant: OKINAWA INSTITUTE OF SCIENCE AND TECHNOLOGY SCHOOL CORPORATION, Okinawa (JP)

(72) Inventors: Mami KAINUMA, Okinawa (JP); Anna PROKHOROVA, Okinawa (JP); Rie HIYANE, Okinawa (JP); Masaki KAZEOKA, Okinawa (JP); Igor GORYANIN, Okinawa (JP); Peter BABIAK, Okinawa (JP)

(73) Assignee: OKINAWA INSTITUTE OF SCIENCE AND TECHNOLOGY SCHOOL CORPORATION, Okinawa (JP)

(21) Appl. No.: 18/076,860

(22) Filed: Dec. 7, 2022

(30) Foreign Application Priority Data
Dec. 7, 2021 (JP) 2021-198900

(51) Int. Cl. C02F 3/00; C02F 3/28

(52) U.S. Cl. CPC C02F 3/005; C02F 3/2866; C02F 2101/163

(57) ABSTRACT

The present invention provides advanced livestock wastewater treatment systems, devices and methods for simultaneous removal of nitrate (nitrite) from treated wastewater at cathode chamber and of organics, suspended solids and malodor (caused by volatile fatty acids) from raw wastewater at anode chamber using anaerobic bioelectrochemical system (BES). The present invention provides a device comprising at least one anode chamber equipped inside with at least one anode, and at least one cathode chamber equipped inside with at least one cathode, wherein the anode chamber is attached to the cathode chamber via separator in order to transport anions or cations between the anode chamber and the cathode chamber.

### TECHNICAL FIELD

### Cross Reference

This application claims the benefit of priority from a Japanese patent application (Japanese Patent Application No. 2021-198900) filed on Dec. 7, 2021, the entire content of which is incorporated herein by reference.

The present application is directed to an advanced swine wastewater treatment system for simultaneous removal of nitrate (nitrite) from treated wastewater, in particular aeration-treated wastewater, at the cathode chamber and of organics, suspended solids and malodor (caused by volatile fatty acids) from raw wastewater at the anode chamber using anaerobic bioelectrochemical system (BES).

### BACKGROUND ART

Sustainable wastewater treatment not only aims at reusing water and minimizing contamination, but also maximizing the recovery of valuable resources such as energy and nutrients (Verstraete et al., 2009). Agricultural wastewater is abundant in recyclable nutrients. Wastewater treatment is of pressing relevance for such places as Japan’s Okinawa Islands, where intensive pig farming significantly increases the amount of wastewater, causing an accumulation of undesirable products that contribute to environmental pollution. This ammonium-rich wastewater from livestock farms is commonly treated by aeration system (Rosso et al., 2008). Nitrate is an ample and harmful inorganic contaminant commonly found in effluent from aeration tanks which are used to remove ammonium-laden wastewaters discharged from livestock farms. Nitrate contamination of wastewater has become a huge concern because of its toxicity to human health and the environment (Powlson et al., 2008). When nitrate is ingested by people, it is converted to nitrite that binds further to the hemoglobin in the body, forming methemoglobin, which is unable to carry oxygen. Therefore excess levels of nitrate in drinking water can cause methemoglobinemia (also called as blue baby syndrome) (Majumdar and Gupta, 2000).

Biological denitrification, the reduction of oxidized nitrogen such as nitrate or nitrite to nitrogen gas, is traditionally achieved by heterotrophic facultative anaerobic microorganisms (Schmidt et al., 2003). While biological denitrification is a well-established technology, it often suffers from competition between aerobic and denitrifying microorganisms for available organics. This competition can result in sub-optimal denitrification due to insufficient substrate supply which often leads to a demand for additional carbon dosing to achieve complete denitrification in wastewater with a low concentration of organics.

Bioelectrochemical systems (BES), a cutting-edge environmental technology, may be able to address the limitations of anaerobic digestion and complement the aeration approach. BES couple the oxidation of an electron donor at the anode with the reduction of an electron acceptor at the cathode, using bacteria to catalyze one or both reactions (Clauwaert et al., 2007). Generally, in the anodic chamber of BES, electrogenic microbes oxidize organics and release electrons to an anode. Nitrogen-containing electron acceptors such as nitrate (NO₃⁻), nitrite (NO₂⁻) and even nitrous oxide (N₂O) can be reduced to nitrogen gas in the cathodic chamber of BES by electrotrophic denitrifiers. Compared to traditional biological nutrient removal techniques, denitrifying BES have obtained high nitrogen removal efficiency even under a low C/N ratio due to bacterial biofilms enriched on the cathodes (Zhang and He, 2012, Tian and Yu, 2020). Understanding the behavior of microbial communities in BES has been the recent focus of many research studies. A Geobacter sp. was found to use a graphite cathode directly as an electron donor source for reducing nitrate to nitrite in a potentiostat-poised half-cell mode (Gregory et al., 2004). Another study using a similar system showed that nitrate is reduced completely to nitrogen gas by electrotrophic microorganisms, which consumed electrons directly from the cathode (Park et al., 2005). These electrotrophic denitrifying bacteria are autotrophs that are able to use the electrode as an electron donor and inorganic carbon (e.g. carbon dioxide and carbonates) as a carbon source. Therefore, biocathodes serve as a safe and endless source of electrons. Moreover, such microbial communities easily adapt to electrically stimulating environments, and can be enriched after the acclimatization period.

Recent advances in the development of biocathodic denitrification in BES have used synthetic wastewater (Park et al., 2017; N Pous et al., 2015). Therefore, the particular interest of the current study was to investigate whether autotrophic denitrification with cathodes can be achieved with swine wastewater, and to identify which conditions are optimal to stabilize such a system. To the best of our knowledge, this work represents the first study to achieve simultaneous treatment of full-strength raw swine wastewater in the anode chamber and the aerated swine wastewater in the cathode chamber. Overall performance and efficiency of carbon and malodor compounds removal in the anode chamber, together with the nitrate removal performance in the cathode chamber, were evaluated. Moreover, a long-term operational run of such a system was conducted.

Previous efforts have elucidated the bacterial communities responsible for autotrophic denitrification (Van Doan et al., 2013; Vilar-Sanz et al., 2013). However, much remains unknown about the long-term survival of these bacteria in livestock wastewater.

### PRIOR ART REFERENCES

### Non-Patent Literature

1. Broman, E., Jawad, A., Wu, X., Christel, S., Ni, G., Lopez-Fernandez, M., Sundkvist, J.E., Dopson, M., 2017. Low temperature, autotrophic microbial denitrification using thiosulfate or thiocyanate as electron donor. Biodegradation 28, 287-301. https://doi.org/10.1007/s10532-017-9796-7
2. Chakraborty, A., Roden, E.E., Schieber, J., Picardal, F., 2011. Enhanced growth of Acidovorax sp. strain 2AN during nitrate-dependent Fe(II) oxidation in batch and continuous-flow systems. Appl. Environ. Microbiol. 77, 8548-8556. https://doi.org/10.1128/AEM.06214-11
3. Chen, W., Wu, D., Wan, H., Tang, R., Li, C., Wang, G., Feng, C., 2017. Carbon-based cathode as an electron donor driving direct bioelectrochemical denitri fi cation in bio fi lm-electrode reactors : Role of oxygen functional groups 118, 310-318. https://doi.org/10.1016/j.carbon.2017.03.062
4. Clauwaert, P., Rabaey, K., Aelterman, P., De Schamphelaire, L., Pham, T.H., Boeckx, P., Boon, N., Verstraete, W., 2007. Biological denitrification in microbial fuel cells. Environ. Sci. Technol. 41, 3354-3360. https://doi.org/10.1021/es062580r
5. Deng, Q., Su, C., Lu, X., Chen, W., Guan, X., Chen, S., Chen, M., 2020. Performance and functional microbial communities of denitrification process of a novel MFC-granular sludge coupling system. Bioresour. Technol. 306, 123173. https://doi.org/10.1016/j.biortech.2020.123173
6. Emerson, D., Field, E.K., Chertkov, O., Davenport, K.W., Goodwin, L., Munk, C., Nolan, M., Woyke, T., 2013. Comparative genomics of freshwater Fe-oxidizing bacteria : implications for physiology , ecology , and systematics 4, 1-17. https://doi.org/10.3389/fmicb.2013.00254
7. Fabisch, M., Beulig, F., Akob, D.M., Küsel, K., 2013. Surprising abundance of Gallionella-related iron oxidizers in creek sediments at pH 4.4 or at high heavy metal concentrations. Front. Microbiol. 4, 1-12. https://doi.org/10.3389/fmicb.2013.00390
8. Feng, Y., Yang, Q., Wang, X., Logan, B.E., 2010. Treatment of carbon fiber brush anodes for improving power generation in air-cathode microbial fuel cells. J. Power Sources 195, 1841-1844. https://doi.org/10.1016/j.jpowsour.2009.10.030
9. Gregoire, K.P., Glaven, S.M., Hervey, J., Lin, B., Tender, L.M., 2014. Enrichment of a High-Current Density Denitrifying Microbial Biocathode. J. Electrochem. Soc. 161, H3049-H3057. https://doi.org/10.1149/2.0101413jes
10. Gregory, K.B., Bond, D.R., Lovley, D.R., 2004. Graphite electrodes as electron donors for anaerobic respiration. Environ. Microbiol. 6, 596-604. https://doi.org/10.1111/j.1462-2920.2004.00593.x
11. Holmes, D.E., Bond, D.R., O′Neil, R.A., Reimers, C.E., Tender, L.R., Lovley, D.R., 2004. Microbial communities associated with electrodes harvesting electricity from a variety of aquatic sediments. Microb. Ecol. 48, 178-190. https://doi.org/10.1007/s00248-003-0004-4
12. Huang, H., Cheng, S., Li, F., Mao, Z., Lin, Z., Cen, K., 2019. Enhancement of the denitrification activity by exoelectrogens in single-chamber air cathode microbial fuel cells. Chemosphere 225, 548-556. https://doi.org/10.1016/j.chemosphere.2019.03.052
13. Irshad, M., Malik, A.H., Shaukat, S., Mushtaq, S., Ashraf, M., 2013. Characterization of Heavy Metals in Livestock Manures 22, 1257-1262.
14. Juretschko, S., Loy, A., Lehner, A., Wagner, M., 2002. The microbial community composition of a nitrifying-denitrifying activated sludge from an industrial sewage treatment plant analyzed by the full-cycle rRNA approach. Syst. Appl. Microbiol. 25, 84-99. https://doi.org/10.1078/0723-2020-00093
15. Khan, S.T., Horiba, Y., Yamamoto, M., Hiraishi, A., 2002. Members of the Family Comamonadaceae as Primary Denitrifiers in Activated Sludge as Revealed by a Polyphasic Approach. Appl. Environ. Microbiol. 68, 3206-3214. https://doi.org/10.1128/AEM.68.7.3206
16. Khilyas, I. V, Sorokin, A.A., Kiseleva, L., Simpson, D.J.W., Fedorovich, V., Sharipova, M.R., Kainuma, M., Cohen, M.F., Goryanin, I., 2017. Comparative Metagenomic Analysis of Electrogenic Microbial Communities in Differentially Inoculated Swine Wastewater-Fed Microbial Fuel Cells. Scientifica (Cairo). 2017, 7616359. https://doi.org/10.1155/2017/7616359
17. Li, P.F., Li, S.G., Li, Z.F., Zhao, L., Wang, T., Pan, H.W., Liu, H., Wu, Z.H., Li, Y.Z., 2013. Co-cultivation of Sorangium cellulosum strains affects cellular growth and biosynthesis of secondary metabolite epothilones. FEMS Microbiol. Ecol. 85, 358-368. https://doi.org/10.1111/1574-6941.12125
18. Liu, B., Mao, Y., Bergaust, L., Bakken, L.R., Frostegård, Å., 2013. Strains in the genus Thauera exhibit remarkably different denitrification regulatory phenotypes 15, 2816-2828. https://doi.org/10.1111/1462-2920.12142
19. Mehrani, M.J., Sobotka, D., Kowal, P., Ciesielski, S., Makinia, J., 2020. The occurrence and role of Nitrospira in nitrogen removal systems. Bioresour. Technol. 303. https://doi.org/10.1016/j.biortech.2020.122936
20.Ming-Ju Chen, Kreuter, J.Y.-T.K., 1996. Kinetics of Pure Cultures ofHydrogen-Oxidizing Denitrifying Bacteria and Modeling of the Interactions AmongThem in Mixed Cultures. J. Anat. 189 (Pt 3, 503-505. https://doi.org/10.1002/bit
21. Park, H. Il, Kim, D.K., Choi, Y.J., Pak, D., 2005. Nitrate reduction using an electrode as direct electron donor in a biofilm-electrode reactor. Process Biochem. 40, 3383-3388. https://doi.org/10.1016/j.procbio.2005.03.017
22. Park, Y., Park, S., Nguyen, V.K., Yu, J., Torres, C.I., Rittmann, B.E., Lee, T., 2017. Complete nitrogen removal by simultaneous nitrification and denitrification in flat-panel air-cathode microbial fuel cells treating domestic wastewater. Chem. Eng. J. 316, 673-679. https://doi.org/10.1016/j.cej.2017.02.005
23. Pous, N., Koch, C., Colprim, J., Puig, S., Harnisch, F., 2014. Extracellular electron transfer of biocathodes: Revealing the potentials for nitrate and nitrite reduction of denitrifying microbiomes dominated by Thiobacillus sp. Electrochem. commun. 49, 93-97. https://doi.org/10.1016/j.elecom.2014.10.011
24. Pous, N, Koch, C., Vii A-Rovira, A., Balaguer, M.D., Colprim, J., Harnisch, F., Puig, S., 2015. Monitoring and engineering reactor microbiomes of denitrifying bioelectrochemical systems †. https://doi.org/10.1039/c5ra12113b
25. Pous, Narcis, Puig, S., Balaguer, M.D., Colprim, J., 2015. Cathode potential and anode electron donor evaluation for a suitable treatment of nitrate-contaminated groundwater in bioelectrochemical systems. Chem. Eng. J. 263, 151-159. https://doi.org/10.1016/j.cej.2014.11.002
26.Powlson, D.S., Addiscott, T.M., Benjamin, N., Cassman, K.G., de Kok, T.M., van Grinsven, H., L′hirondel, J.-L., Avery, A.A., van Kessel, C., 2008. When Does Nitrate Become a Risk for Humans? J. Environ. Qual. 37, 291-295. https://doi.org/10.2134/jeq2007.0177
27.Prokhorova, K. Sturm-Richter, A. Doetsch, J.G., 2017. Resilience, Dynamics, and Interactions within a Model Multispecies Exoelectrogenic-Biofilm Community. J of Appl. and Environ. Microbiol, 83, 1-15.
28. Puig, S., Serra, M., Vilar-Sanz, A., Cabré, M., Bañeras, L., Colprim, J., Balaguer, M.D., 2011. Autotrophic nitrite removal in the cathode of microbial fuel cells. Bioresour. Technol. https://doi.org/10.1016/j.biortech.2010.12.100
29. Rosso, D., Larson, L.E., Stenstrom, M.K., 2008. Aeration of large-scale municipal wastewater treatment plants: State of the art. Water Sci. Technol. 57, 973-978. https://doi.org/10.2166/wst.2008.218
30. Schmidt, I., Sliekers, O., Schmid, M., Bock, E., Fuerst, J., Kuenen, J.G., Jetten, M.S.M., Strous, M., 2003. New concepts of microbial treatment processes for the nitrogen removal in wastewater. FEMS Microbiol. Rev. 27, 481-492. https://doi.org/10.1016/S0168-6445(03)00039-1
31. Shrestha, N.K., Hadano, S., Kamachi, T., Okura, I., 2001. Conversion of ammonia to dinitrogen in wastewater by Nitrosomonas europaea. Appl. Biochem. Biotechnol. - Part A Enzym. Eng. Biotechnol. 90, 221-232. https://doi.org/10.1385/ABAB:90:3:221
32. Sun, J., Cao, H., Wang, Z., 2020. Progress in nitrogen removal in bioelectrochemical systems. Processes 8. https://doi.org/10.3390/pr8070831
33. Tang, R., Wu, D., Chen, W., Feng, C., Wei, C., 2017. Biocathode denitrification of coke wastewater effluent from an industrial aeration tank: Effect of long-term adaptation. Biochem. Eng. J. 125, 151-160. https://dio.org/10.1016/j.bej.2017.05.022
34. Tian, T., Yu, H.Q., 2020. Denitrification with non-organic electron donor for treating low C/N ratio wastewaters. Bioresour. Technol. 299, 122686. https://doi.org/10.1016/j.biortech.2019.122686
35. Tilman, D., Isbell, F., Cowles, M., 2014. Biodiversity and Ecosystem Functioning. Annu. Rev. Ecol. Evol. Syst. 45, 471-493. https://doi.org/10.1146/annurev-ecolsys-120213-091917
36. Van Doan, T., Lee, T.K., Shukla, S.K., Tiedje, J.M., Park, J., 2013. Increased nitrous oxide accumulation by bioelectrochemical denitrification under autotrophic conditions: Kinetics and expression ofdenitrification pathway genes. Water Res. 47, 7087-7097. https://doi.org/10.1016/j.watres.2013.08.041
37. Vasieva, O., Sorokin, A., Szydlowski, L., Goryanin, I., 2019. Do Microbial Fuel Cells have Antipathogenic Properties ? Computer Science & Systems Biology Do Microbial Fuel Cells have Antipathogenic Properties ? J. Comput. Sci. Syst. Biol. 12, 57-70. https://doi.org/10.4172/0974-7230.1000301
38. Verstraete, W., Van de Caveye, P., Diamantis, V., 2009. Maximum use of resources present in domestic “used water.” Bioresour. Technol. 100, 5537-5545. https://doi.org/10.1016/j.biortech.2009.05.047
39. Vilajeliu-Pons, A., Puig, S., Pous, N., Salcedo-Dávila, I., Bañeras, L., Balaguer, M.D., Colprim, J., 2015. Microbiome characterization of MFCs used for the treatment of swine manure. J. Hazard. Mater. 288, 60-68. https://doi.org/10.1016/j.ihazmat.2015.02.014
40. Vilajeliu-Pons, A., Puig, S., Salcedo-Dávila, I., Balaguer, M.D., Colprim, J., 2017. Long-term assessment of six-stacked scaled-up MFCs treating swine manure with different electrode materials. Environ. Sci. Water Res. Technol. 3, 947-959. https://doi.org/10.1039/c7ew00079k
41. Vilar-Sanz, A., Puig, S., García-Lledó, A., Trias, R., Balaguer, M.D., 2013. Denitrifying Bacterial Communities Affect Current Production and Nitrous Oxide Accumulation in a Microbial Fuel Cell) Denitrifying Bacterial Communities Affect Current Production and Nitrous Oxide Accumulation in a Microbial Fuel. Cell. PLoS ONE 8, 63460. https://doi.org/10.1371/journal.pone.0063460
42. Vo, C.-D.-T., Michaud, J., Elsen, S., Faivre, B., Bouveret, E., Barras, F., Fontecave, M., Pierrel, F., Lombard, M., Pelosi, L., 2020. The O 2 -independent pathway of ubiquinone biosynthesis is essential for denitrification in Pseudomonas aeruginosa . J. Biol. Chem. jbc.RA120.013748. https://doi.org/10.1074/jbc.ra120.013748
43. Wang, H., Jiang, S.C., Wang, Y., Xiao, B., 2013. Substrate removal and electricity generation in a membrane-less microbial fuel cell for biological treatment of wastewater. Bioresour. Technol. 138, 109-116. https://doi.org/10.1016/j.biortech.2013.03.172
44. Yang, N., Zhan, G., Li, D., Wang, X., He, X., Liu, H., 2019. Complete nitrogen removal and electricity production in Thauera-dominated air-cathode single chambered microbial fuel cell. Chem. Eng. J. 356, 506-515. https://doi.org/10.1016/j.cej.2018.08.161
45. Yu, L., Yuan, Y., Chen, S., Zhuang, L., Zhou, S., 2015. Direct uptake of electrode electrons for autotrophic denitri fi cation by Thiobacillus denitrificans 60, 126-130. https://doi.org/10.1016/j.elecom.2015.08.025
46. Zhang, N., Chen, H., Lyu, Y., Wang, Y., 2019. Nitrogen removal by a metal-resistant bacterium, Pseudomonas putida ZN1, capable of heterotrophic nitrification-aerobic denitrification. J. Chem. Technol. Biotechnol. 94, 1165-1175. https://doi.org/10.1002/jctb.5863

### SUMMARY OF INVENTION

### Technical Problems

Nitrate in wastewater is of concern due to its negative effects on human and environmental health. In Japan, the livestock industry was under a temporary discharge level of 500 mg NO₃⁻-N/L (as of December 2021), which was lowered to 400 mg NO₃⁻-N/L (July 2022), which is expected to be further lowered to 300 mg NO₃⁻-N/L or 200 mg NO₃⁻-N/L, and eventually to the standard with other industries (100 mg NO₃⁻-N/L).

Nitrate is designated as toxic compound. Also, phosphate in livestock wastewater is under a temporal discharge limit (22 mg/L) and will be lowered to the standard (16 mg/L). The activated sludge process, widely used in conventional wastewater treatment systems, generally removes ammonia but not nitrate and phosphate. To remove nitrate, the conventional wastewater system requires maintaining C/N ratio of above 3-5 and low dissolved oxygen (DO) which are both difficult to control.

Conventional swine wastewater treatment utilizes aeration (activated sludge process) which does not remove phosphate, cause of eutrophication and scarce resource.

Conventional swine wastewater treatment (activated sludge process) generates excess sludge during COD removal which requires periodic or even daily removal which is one of the major operating costs together with electricity to run aeration.

### Solution to Problem

The present invention provides advanced livestock wastewater treatment devices, systems, and methods for simultaneous removal of nitrate (nitrite) from aeration-treated wastewater (hereinafter also referred to as aerated wastewater or secondary treated wastewater) at cathode chamber and of organics, suspended solids and malodor (volatile fatty acids) from raw wastewater at anode chamber using anaerobic bioelectrochemical system (BES).

The advanced wastewater treatment device comprises at least two separate chambers: The anode chamber oxidizes BOD, and removes SS, malodor, and pathogens from raw swine wastewater and, simultaneously, the cathode chamber reduce nitrate to nitrogen gas from aerated wastewater. The raw wastewater from the livestock house may flow into the anode chamber, which reduces the organic load on the aeration tank thereby extends its lifespan, and lowers the excess sludge removal cost associated with aeration. Subsequently the anodetreated water may go into the existing aeration tank to remove remaining BOD and nitrify ammonium to nitrate. The aeration tank-treated water may be used as the aerated wastewater.

The present invention includes the following embodiments:
(1) A device for simultaneously denitrifying aerated wastewater and treating raw wastewater, containing:
   at least one anode chamber equipped inside with at least one anode, for treating raw wastewater and
   at least one cathode chamber equipped inside with at least one cathode, for denitrifying aerated wastewater;
   wherein the anode chamber is attached to the cathode chamber via separator in order to transport anions and/or cations between the anode chamber and the cathode chamber.
(2) The device according to (1), wherein the cathode chamber and/or anode chamber further comprise inside a reference electrode.
(3) The device according to (1), wherein the anode and/or cathode are conductive electrode.
(4) The device according to (3) wherein the conductive electrode(s) comprise(s) carbon fibers or stainless steel.
(5) The device according to (1), wherein at least one of the anode and cathode chambers containing a means for stirring inside the chamber continuously or periodically.
(6) The device according to (1), wherein the device is to be connected to an aeration tank, preferably wherein the aeration tank is an existing one that was in place before the device of the disclosure is deployed on site, thereby allowing farmers to meet new regulations in relation to discharge regulations in relation to nitrates, nitrites and/or ammoniums, and the device may be connected to an aeration tank directly or through one or more intermediate ponds or containers such as a precipitation tank.

(1A) A system for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite; containing
1) the device according to (1) or (2), and
2) a means for adjusting the potential between the cathode and the anode or between the cathode or the anode versus the reference electrode,
   wherein the means is connected to the anode and the cathode, or to the anode, the cathode and the reference electrode;
   in the anode chamber, electrogenic bacteria degrade the organic compounds in the raw wastewater and provide electrons through the anode; and
   in the cathode chamber, denitrifying bacteria receive the electrons via the cathode and reduce the nitrate and/or nitrite in the aerated wastewater to N₂ gas.

(2A) The system according to (1A), wherein the means for adjusting the potential is a potentiostat or an external resistor or open circuit potential (OCP) mode.

(3A) The system according to (1A), wherein the electrogenic bacteria comprise at least one kind of bacteria selected from the group of consisting of species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus, and Ralstonia.

(4A) The system according to (1A), wherein the denitrifying bacteria comprise at least one kind of bacteria selected from the group of consisting of species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, and Maribacter.

(1B) A method for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite; by using a device containing
at least one anode chamber equipped inside with at least one anode, and
at least one cathode chamber equipped inside with at least one cathode, wherein the anode chamber is attached to the cathode chamber via separator in order to transport anions and/or cations between the anode chamber and the cathode chamber, comprising
   1) a step of adding the raw wastewater into the anode chamber and adding the aerated wastewater into the cathode chamber; and then
   2) a step of adjusting the potential between the anode and the cathode, wherein, in the anode chamber, electrogenic bacteria degrade the organic compounds and thereby provide electrons through the anode; and in the cathode chamber, denitrifying bacteria receive the electrons via the cathode and reduce the nitrate and/or nitrite to N₂ gas.

(2B) A method for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite;
by using a device containing
   at least one anode chamber equipped inside with at least one anode,
   at least one cathode chamber equipped inside with at least one cathode, and
   a reference electrode in the cathode chamber or anode chamber wherein the anode chamber is attached to the cathode chamber via separator in order to transport anions and/or cations between the anode chamber and the cathode chamber, comprising
      1) a step of adding the raw wastewater into the anode chamber and adding the aerated wastewater into the cathode chamber; and then
      2) a step of adjusting potential either to the cathode or the anode versus the reference electrode,
wherein, in the anode chamber, electrogenic bacteria degrade the organic compounds and thereby provide electrons through the anode; and in the cathode chamber(s), denitrifying bacteria receive the electrons via the cathode and reduce the nitrate and/or nitrite to N₂ gas.

(3B) The method according to (1B) or (2B), wherein the electrogenic bacteria comprise at least one kind of bacteria selected from the group of consisting of species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus, and Ralstonia.

(4B) The method according to (1B) or (2B), wherein the denitrifying bacteria comprise at least one kind of bacteria selected from the group of consisting of species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, and Maribacter.

(5B) The method according to (1B) or (2B), wherein the raw wastewater is livestock wastewater or supernatant thereof.

(6B) The method according to (1B) or (2B), wherein the raw wastewater is swine wastewater or supernatant thereof.

(7B) The method according to (1B) or (2B), wherein the aerated wastewater is aerated livestock wastewater or supernatant thereof with low level of organic compounds.

(8B) The method according to (1B) or (2B), wherein the aerated wastewater is aerated swine wastewater or supernatant thereof with low level of organic compounds.

(9B) The method according to (2B), wherein the potential is applied and adjusted to the cathode at -0.2 to -0.8 V vs the reference electrode (Ag/AgCl) at the step 2).

(10B) The method according to (2B), wherein the potential is applied and adjusted to the cathode at -0.4 to-0.6 V vs the reference electrode (Ag/AgCl) at the step 2).

(11B) The method according to (1B) or (2B), further comprising,

0) a step of inoculating the anode chamber and/or the cathode chamber with activated sludge at an amount of 0% to 60% capacity thereof.

(12B). The method according to (11B), wherein the step 0 is a step of inoculating the anode chamber and/or the cathode chamber with the activated sludge at an amount of 20% to 25% capacity thereof.

(13B) The method according to (1B) or (2B), wherein the aerated wastewater after the step 2 comprises total 100 mg/L or less of NO₃⁻ and NO₂⁻ as nitrogen equivalent.

(1C) A method for simultaneously performing anaerobiotic elimination of organic compounds such as organics, suspended solids and volatile fatty acids, and pathogens from raw wastewater comprising electrogenic bacteria and the organic compounds, and removal of nitrate and/or nitrite and phosphate from aerated wastewater comprising denitrifying bacteria and the nitrate and/or nitrite and phosphate; by using a device containing
at least one anode chamber equipped inside with at least one anode, and
at least one cathode chamber equipped inside with at least one cathode, wherein the anode chamber is attached to the cathode chamber via separator in order to transport anions and/or cations between the anode chamber and the cathode chamber, comprising
   1) adding the raw wastewater into the anode chamber and adding the aerated wastewater into the cathode chamber; and then
   2) adjusting the potential between the anode and the cathode, wherein, in the anode chamber, the electrogenic bacteria degrade the organic compounds and thereby provide electrons through the anode; and in the cathode chamber, the denitrifying bacteria receive the electrons via the cathode and reduce the nitrate and/or nitrite to N₂ gas, and salts of the phosphate are precipitated in the cathode chamber.

(2C) A method for simultaneously performing anaerobiotic elimination of organic compounds such as organics, suspended solids and volatile fatty acids, and pathogens from raw wastewater comprising electrogenic bacteria and the organic compounds, and removal of nitrate and/or nitrite from aerated wastewater comprising denitrifying bacteria and the nitrate and/or nitrite;
by using a device containing
   at least one anode chamber equipped inside with at least one anode,
   at least one cathode chamber equipped inside with at least one cathode, and
   a reference electrode in the cathode chamber or anode chamber wherein the anode chamber is attached to the cathode chamber via separator in order to transport anions and/or cations between the anode chamber and the cathode chamber, comprising
      1) adding the raw wastewater into the anode chamber and adding the aerated wastewater into the cathode chamber; and then
      2) adjusting potential either to the cathode or the anode versus the reference electrode, wherein, in the anode chamber, the electrogenic bacteria degrade the organic compounds and thereby provide electrons through the anode; and in the cathode chamber, the denitrifying bacteria receive the electrons via the cathode and reduce the nitrate and/or nitrite to N₂ gas, and salts of the phosphate are precipitated in the cathode chamber.

(3C) The method according to claim 24 or 25, wherein more than 30% of phosphate phosphorus present in the aerated wastewater is removed by step 2) in terms of the amount by weight of phosphorus.

(A1) A device comprising
at least one anode chamber(s) equipped inside with at least one anode(s), and
at least one cathode chamber(s) equipped inside with at least one cathode(s) wherein the anode chamber(s) are attached to the cathode chamber(s) via anion exchange membrane (s) or cation exchange membrane (s) in order to transfer anions or cations movable between the anode chamber(s) and the cathode chamber(s); and
wherein the anode chamber(s) comprise(s) inside electro-genic bacteria, preferably on the surface of the anode(s), and the cathode chamber(s) comprise(s) inside denitrifying bacteria, preferably on the surface of the cathode(s).

(A2) The device according to (A1), the cathode chamber(s) further comprise(s) inside reference electrode(s). (A3) The device according to (A1) or (A2), the anode(s) and/or cathode(s) are carbon electrode(s).

(A4) The device according to any one of (A1) ~ (A3), wherein the electro-genic bacteria comprise at least one kind of bacteria selected from the group of consisting of species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus, and Ralstonia.

The device according to any one of (A1) ~ (A4), wherein the denitrifying bacteria comprise at least one kind of bacteria selected from the group of consisting of species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, Methylobacter, Nitrosococcus, Mesorhizobium and Maribacter.

(A1A) A system comprising
1) a device according to (A2)
2) a potentiostat for applying potential to the cathode electrodes against the reference electrode(s), external resister mode, or open circuit mode.

(A1B) A method simultaneously for eliminating organic compounds such as organics, suspended solids and volatile fatty acids from raw wastewater containing the organic compounds and for removing nitrate and/or nitrite from aerated wastewater containing the nitrate and/or nitrite, comprising
1) a step of adding the raw wastewater into the anode chamber(s) of a device of (A2) and adding the aerated wastewater into the cathode chamber(s) of the device; and then
2) a step of applying potential to the cathod(s), preferably using the reference electrode(s), both of which are connected to a potentiostat,
wherein, in the anode chamber(s), the electro-genic bacteria degrade the organic compounds and thereby provide electrons with the anode(s) connected to the potentiostat; and in the cathode chamber(s), the denitrifying bacteria receive the electrons via the cathode(s) and reduce the nitrate and/or nitrite, with the electrons, preferably into NO, N₂O and/or N₂.

(A2B) The method according to (A1B), wherein the raw wastewater is livestock wastewater or supernatant thereof, preferably swine wastewater or supernatant thereof.

(A3B) The method according to (A1B), wherein the aerated wastewater is aerated livestock wastewater or supernatant thereof, preferably aerated swine wastewater or supernatant thereof with low level of organic compounds.

(A4B) The method according to (A1B), wherein the raw wastewater comprises the organic compounds and NH₄⁺ and the aerated wastewater is the raw wastewater after eliminating the organic compounds at step 2) and then converting the NH₄⁺ into nitrate and/or nitrite by nitrifying bacteria under aeration.

(A5B) The method according to (A1B), wherein the cathode(s) poise(s) at -0.2 to -0.8 V (Ag/AgCl), preferably -0.4 to -0.6 V (Ag/AgCl), at step 2).

(A6B) The method according to (A1B), wherein at least step 2) is performed at the anaerobic condition.

### Advantageous Effects of the Invention

One embodiment of the present inventions may show the following effects: 1. Tertiary treatment of aerated wastewater (in the cathode chamber) The advantageous effect can be that the system uses electrodes as electron donor for autotrophic denitrifying bacteria which are able to reduce nitrate to nitrogen gas without labor intensive organic level or dissolved oxygen (DO) level adjustment and extra chemical addition, the conventional methods require. The nitrate containing wastewater with low organics such as nitrified wastewater by aeration, nitrate contaminated groundwater or aquaculture water are not limited but suited for this system (low C/N wastewater). In addition, the system can also allow conventional heterotrophic denitrification. Nitrate-nitrogen can be removed down to standard discharge level (100 mg/L).

2. Secondary treatment of raw wastewater (in the anode chamber) One embodiment of the present inventions may work as secondary wastewater treatment which reduces organic load (over 80%) from raw wastewater, consequently reducing the burden for existing aeration tank, saving aeration cost and total operational cost.

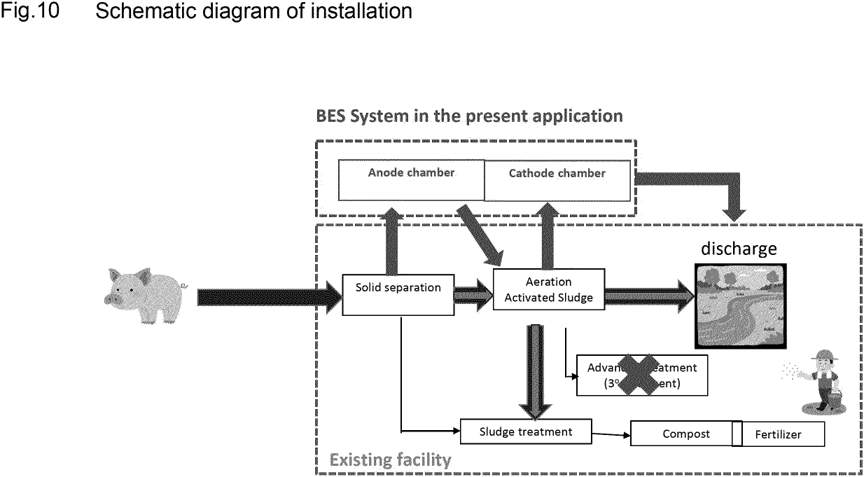

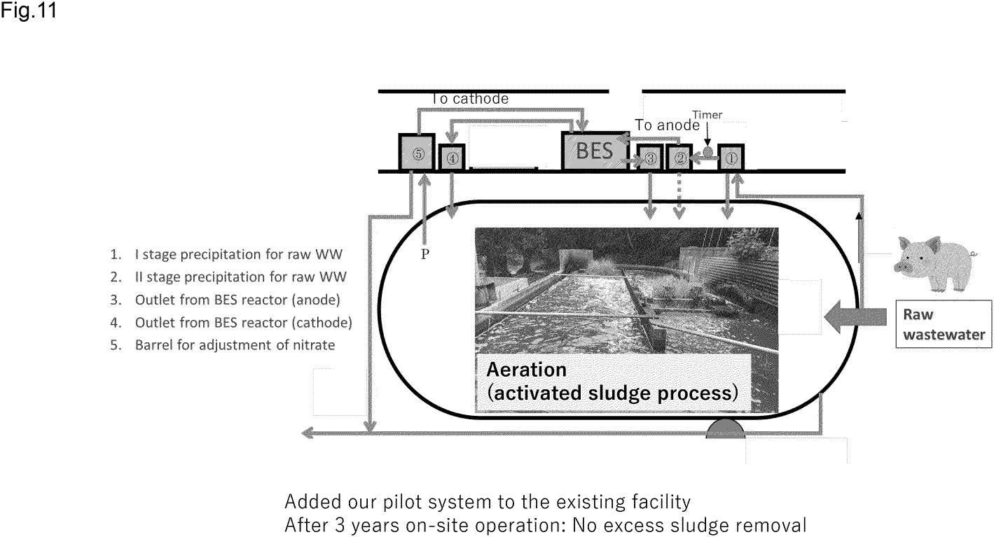

In addition, the system may remove suspended solids (80%) and malodor (80%) and E. coli (pathogenic indicator). This system can be added to the existing wastewater treatment as advanced treatment system (FIGS. 10 and 11). This system is consisting of serial precipitation tanks to remove large particles from wastewater, and the BES bioreactor. Overall advantage of this system is reducing operational costs to the conventional treatment system including excess sludge removal, chemical additions and electricity usage, and thus reduce CO₂ emission.

### BRIEF DESCRIPTION OF DRAWINGS

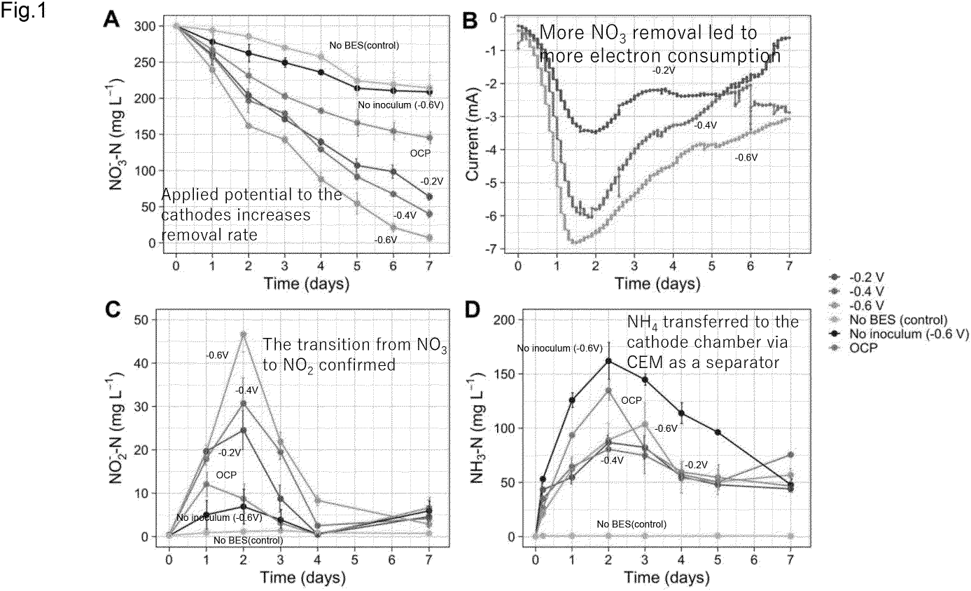

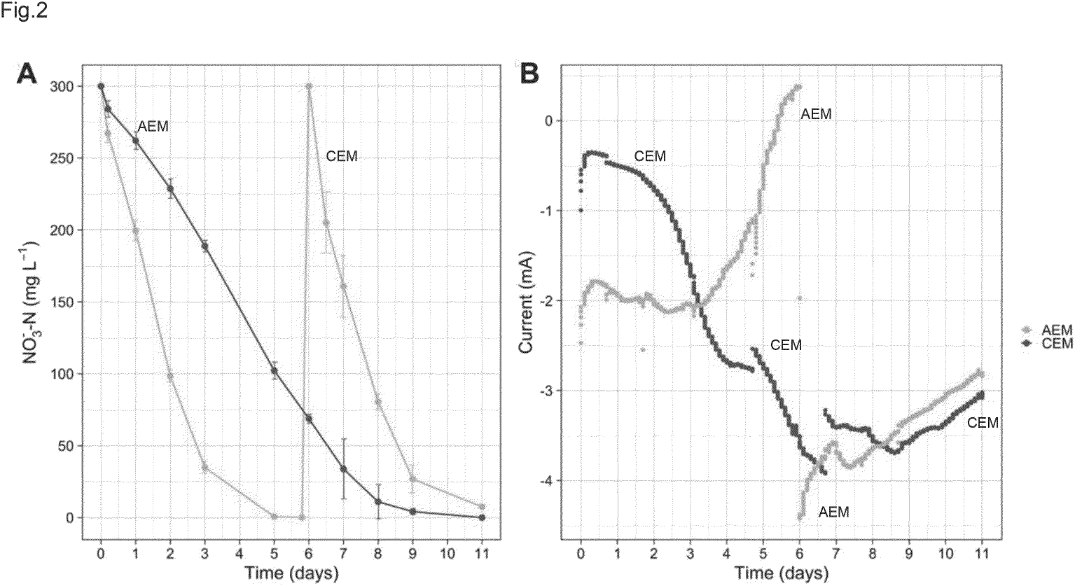

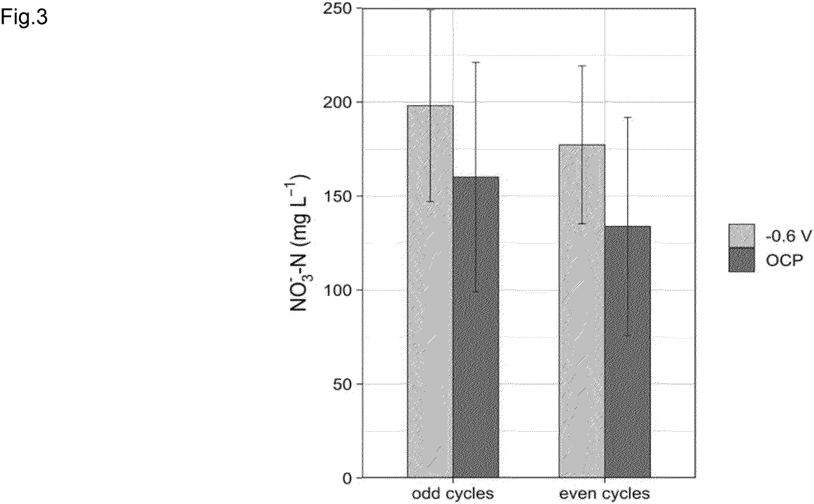

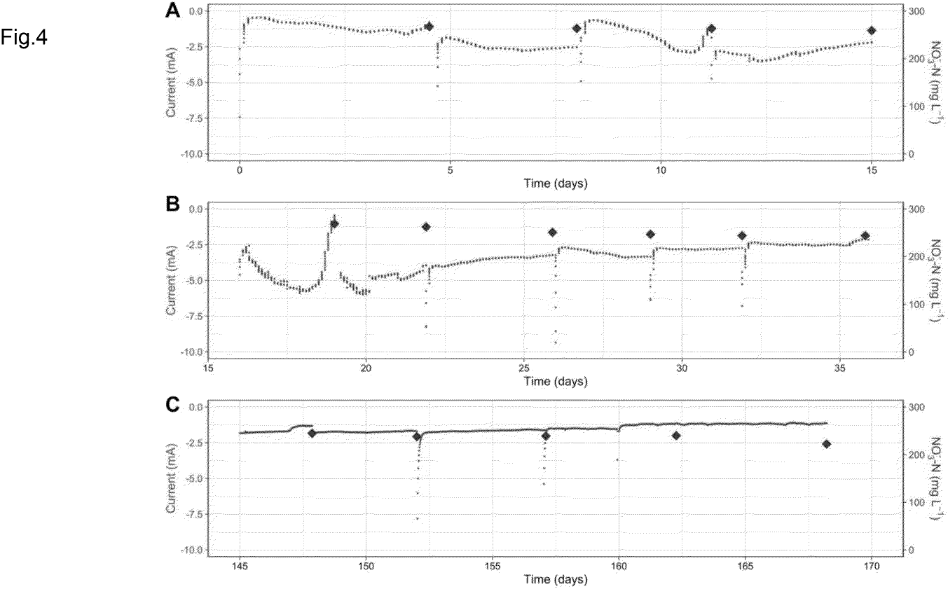

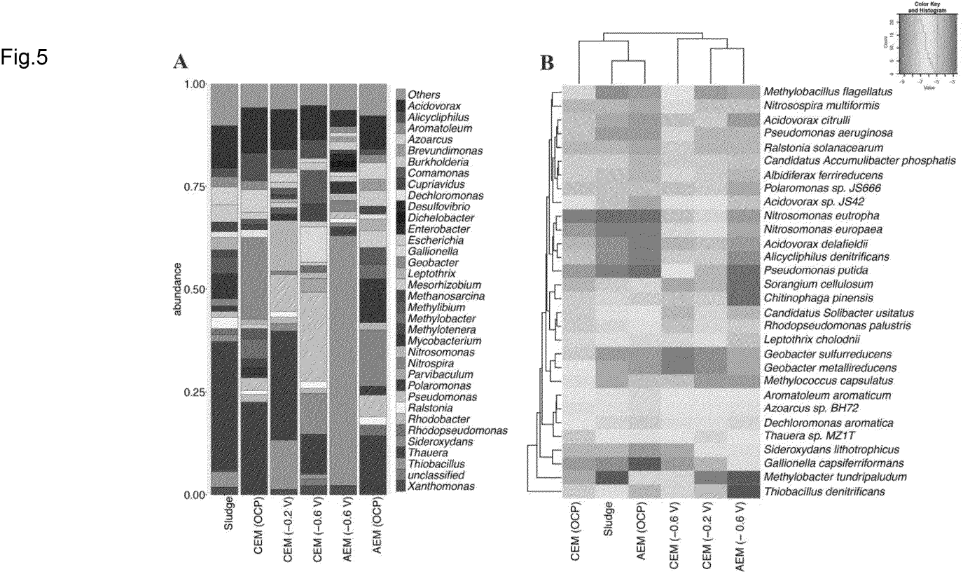

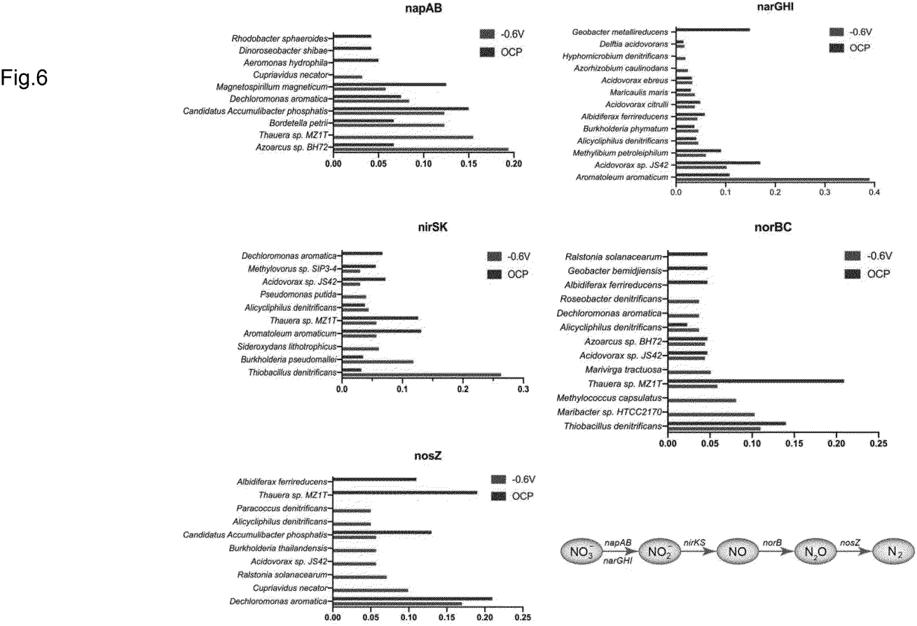

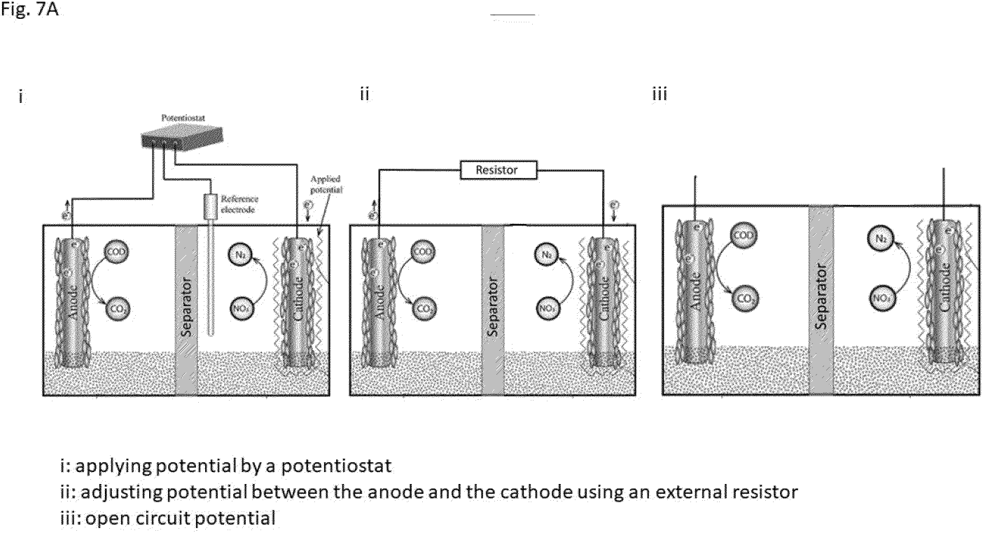

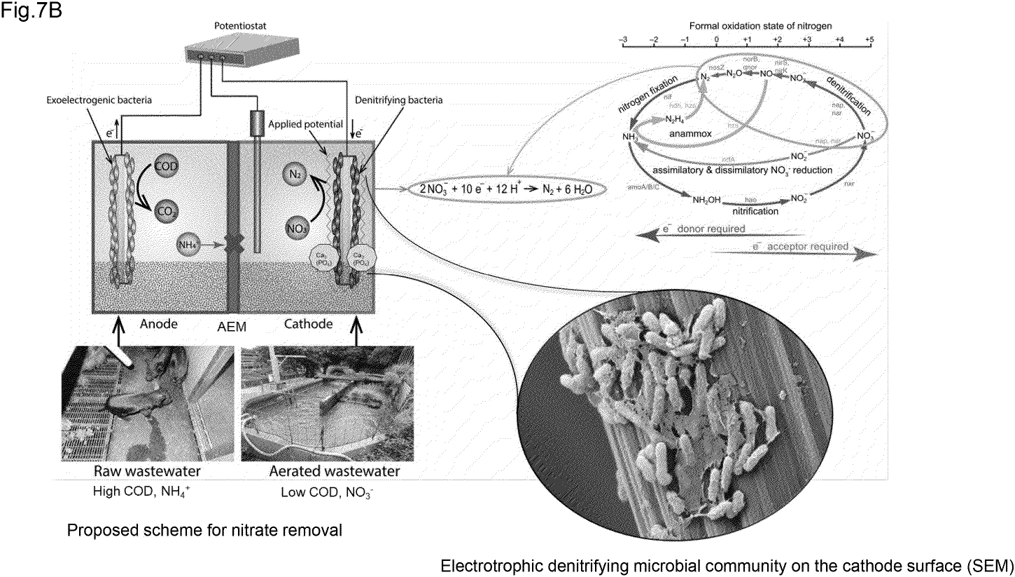

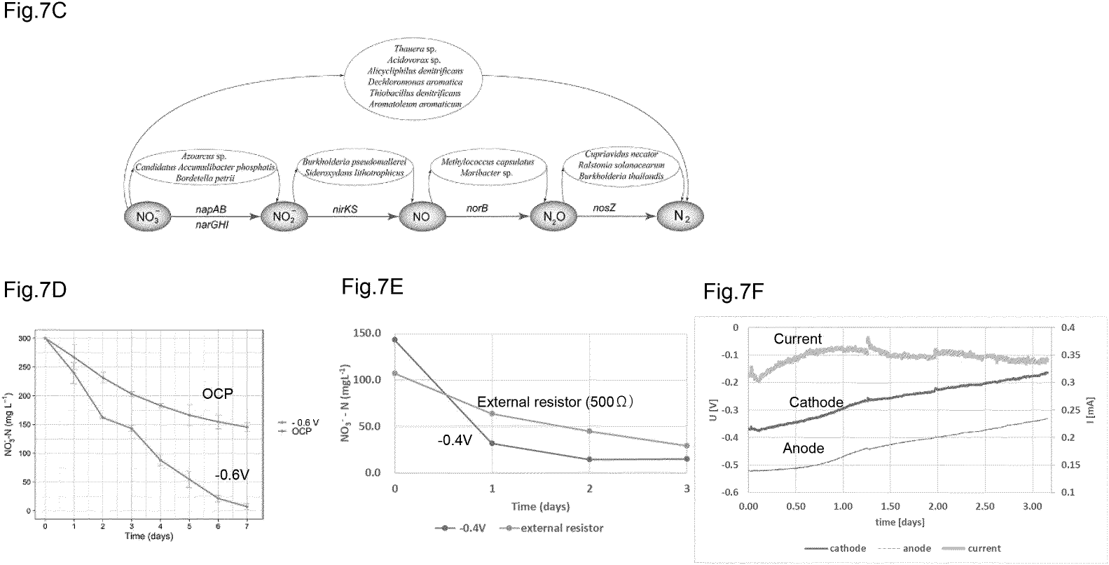

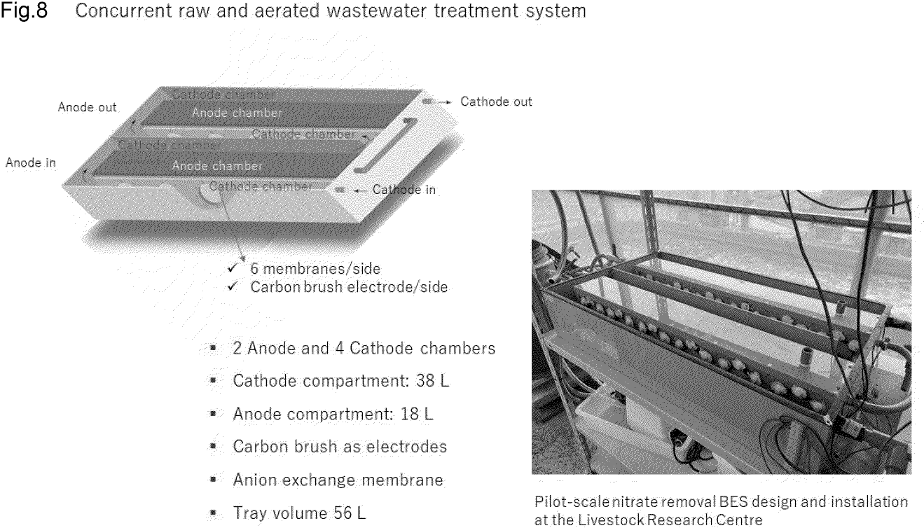

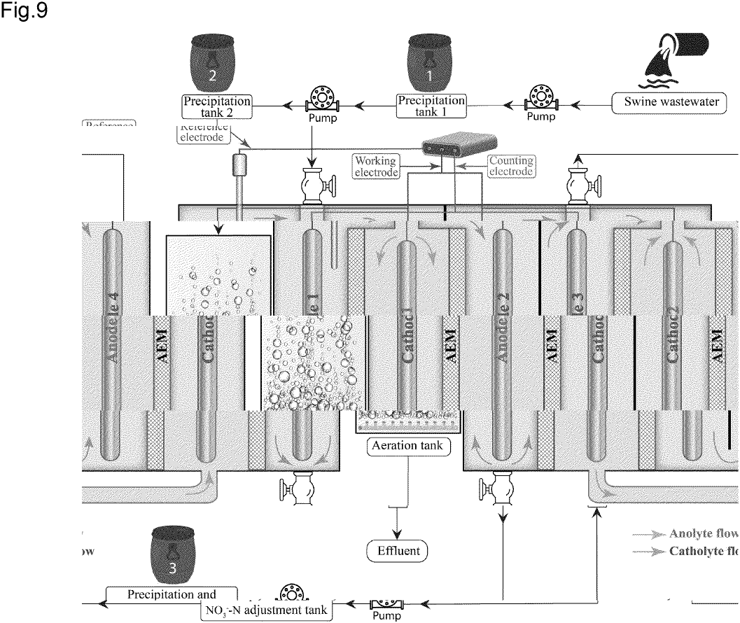

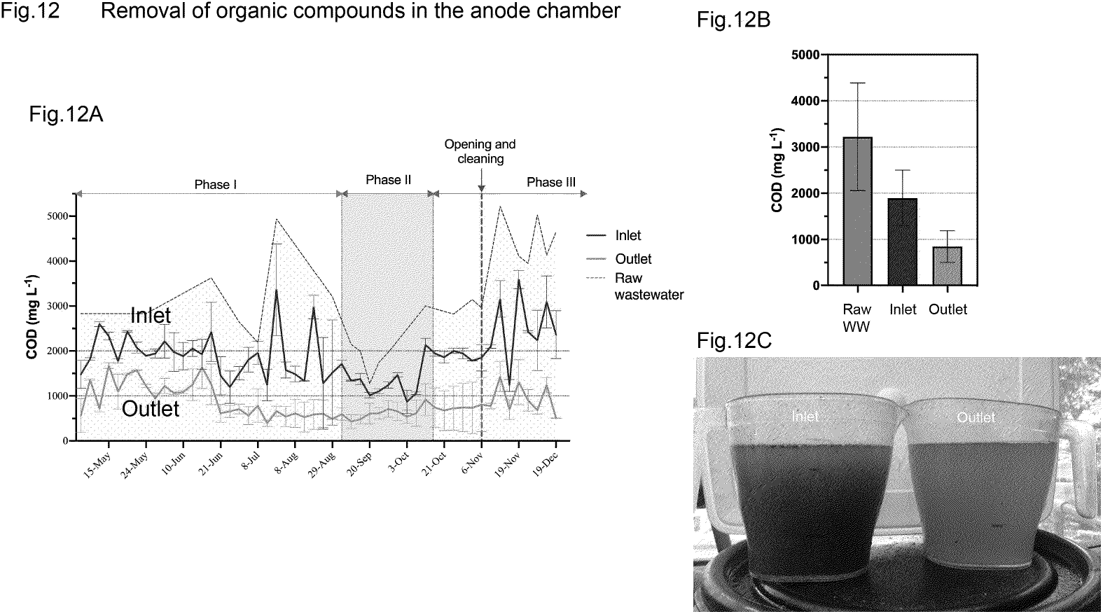

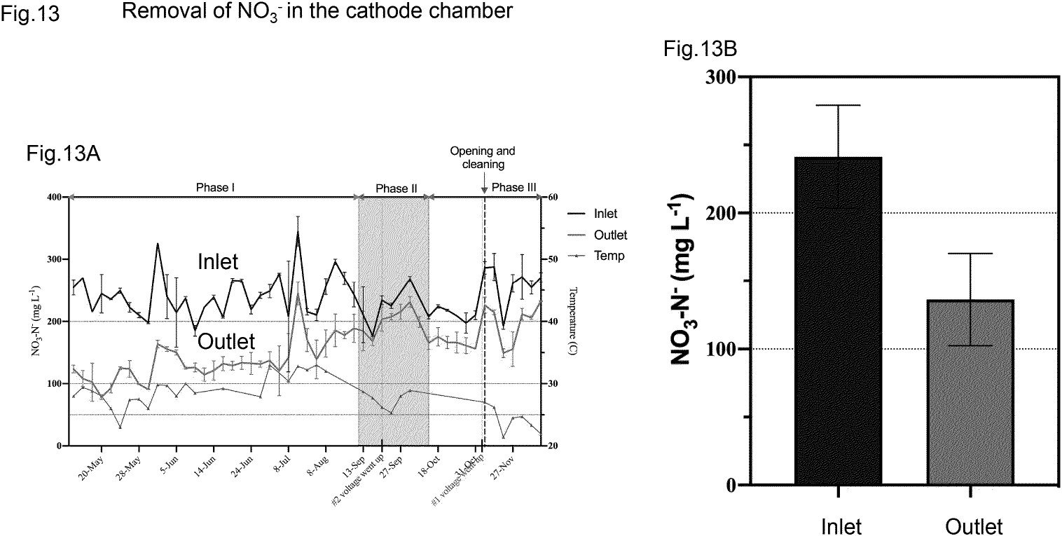

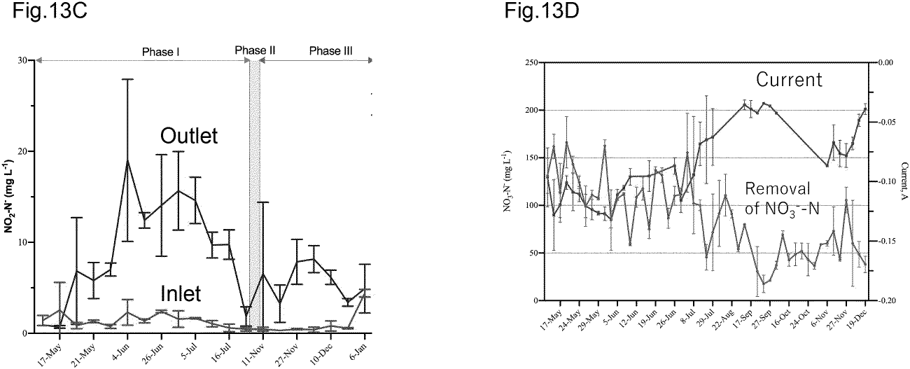

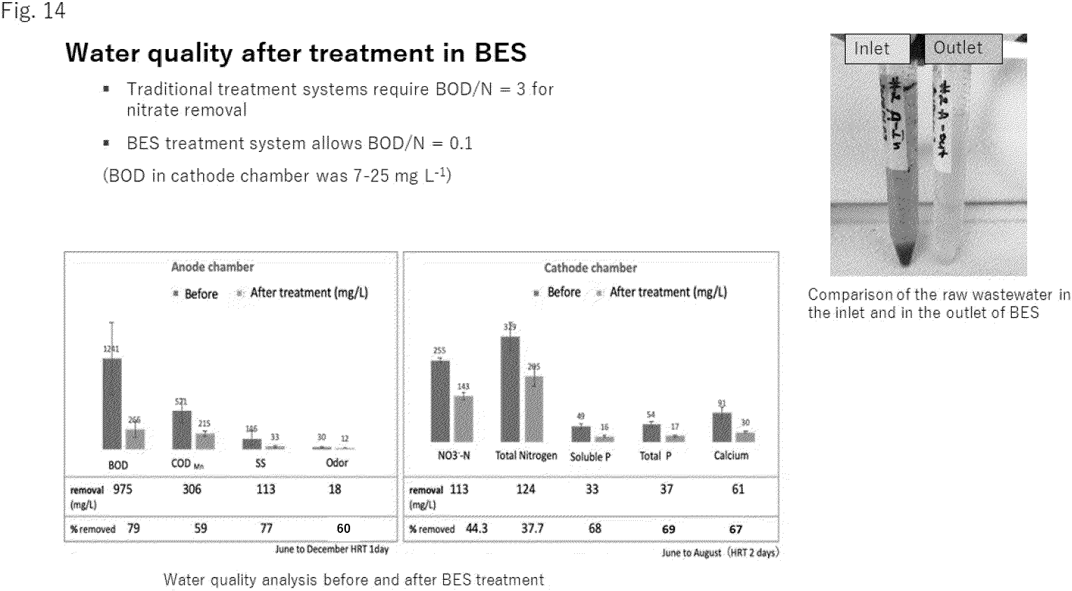

The patent or application file contains at least one drawing executed in color. Copies of this patent or patent application publication with color drawing(s) will be provided by the Office upon request and payment of the necessary fee.

[FIG. 1] Biocathodic denitrification performance in short-term experiment. A) NO₃⁻-N removal with initial concentration of 300 mg L⁻¹; B) cathodic current generation curves under applied potentials of -0.6 V vs Ag/AgCl, -0.4 V vs Ag/AgCl and -0.2 V vs Ag/AgCl; C) NO₂⁻-N concentration; D) NH₄⁺-N concentration.

[FIG. 2] Biocathodic denitrification performance with cation (CEM) vs anion (AEM) exchange membranes A) NO₃⁻-N removal with initial concentration of 300 mg L⁻¹, where BES with AEM were supplemented with additional 300 mg L⁻¹ of nitrate-nitrogen due to its complete removal at day 6; B) cathodic current generation curves.

[FIG. 3] Average cumulative removal of NO₃⁻-N in long-term experiment. BES were run for 45 cycles each with HRT of 3 days using a fed-batch mode, where at every odd cycle number the anode chamber was filled with untreated wastewater and the cathode chamber with aerated wastewater, and at every even cycle number only the cathode chamber was filled with a new batch of aerated wastewater.

[FIG. 4] Current output and cumulative amount of the reduced nitrate at the last day of the cycle during the operation of A) 0-15 days; B) 15-35 days; C) 145-170 days. Blue rhombus: cumulative amount of the removed NO₃⁻-N at day 3.

[FIG. 5] Taxonomic classification of the microbial communities on the cathodes. The relative abundances at A) genus level and B) species level (heatmap of the top 30 closest matching species. The color intensity indicates the value of relative abundance after a base-2 logarithmic transformation was applied). CEM: cation exchange membrane (short-term experiment), AEM: anion exchange membrane (long-term experiment).

[FIG. 6] The abundance of dominant closest matching species involved in denitrification. Composition of denitrifying microbial communities in samples from Stage I under applied potential of -0.6 V and OCP shown with abundance higher than 3%.

[FIG. 7] A schematic diagram of one embodiment of the present application. FIG. 7A shows one embedment of the device having one anode chamber and one cathode chamber. 7A-i. applying potential by potentiostat, ii. adjusting potential by an external resistor and iii. open circuit potential. FIG. 7B shows one embodiment of the cascade of the method in the present application. Microbial community containing denitrifying bacteria is confirmed to be localized on the surface on the cathode by SEM. FIG. 7C shows a conversion cascade from NO₃⁻ to N₂ by denitrifying bacteria. FIG. 7D shows removal of NO₃⁻ was enhanced by applying potential to the cathode in the cathode chamber. FIG. 7E Nitrate removal by applying a potential to the cathode (-0.4 V) and using an external resistor (500 Ω). FIG. 7F Cathode potential, anode potential and the current during the external resistor experiment (R=500 Ω) in time.

[FIG. 8] Demonstration reactor system having multiple anode chambers and multiple cathode chambers.

[FIG. 9] A schematic diagram of the demonstration reactor system. 2 Anode and 4 Cathode chambers; Cathode compartment: 36 L; Anode compartment: 18 L; Carbon brush/fiber as electrode; Anion exchange membrane; Tray volume ~ 65 L; - 0.4 V vs Ag/AgCl (at cathode). The raw wastewater is treated biologically including electro-genic bacteria in the anode chambers. And the treated raw wastewater is transferred to an aeration tank and the remaining organics is treated by aeration as well as treated with nitrifying bacteria which can convert NH₄⁺ into NO₃⁻ The aerated wastewater is transferred as aerated wastewater to the cathode chambers.

[FIG. 10] A schematic diagram of system installation.

[FIG. 11] Installation to an existing wastewater treatment facility.

[FIG. 12] Removal of organic compounds in the anode chamber. The treatment in the anode chamber reduces COD in the raw wastewater. FIG. 12A shows time course of COD. FIG. 12B shows the COD values and FIG. 12C shows turbidity.

[FIG. 13] Removal of NO₃⁻ in the cathode chamber. FIG. 13A shows time course of NO₃⁻. FIG. 13B shows the concentration of NO₃⁻. FIG. 13C shows time course of NO₂⁻, indicating that NO₃⁻ is reduced and converted by denitrifying bacteria. FIG. 3D shows the relationship between the acquired current and NO₃⁻ removal.

[FIG. 14] Summary of water quality after the treatment in the system.

### PREFERRED EMBODIMENT

Unless otherwise noted, all terms in the present invention have the same meaning as commonly understood by one with ordinary skill in the art to which this disclosure belongs. The singular terms “a,” “an,” and “the” include plural referents unless context indicates otherwise. Similarly, the word “or” is intended to include “and” unless the context indicates otherwise. The term “a few” means numeral from 2 to 3 in this description. The term “several” means numeral from 2 to 6 in this description. In case of conflict, the present specification, including explanations of terms, will control. In addition, the materials, methods and examples are illustrative only and not intended to be limiting.

In one embodiment, the present application includes a device comprising at least one anode chamber equipped inside with at least one anode(s), and at least one cathode chamber equipped inside with at least one cathode. The anode chamber may be equipped with at least one inlet for adding raw wastewater into the anode chamber and at least one outlet for recovering the treated raw wastewater from the anode chamber. In the anode chamber, the inlet may be the same as the outlet. The cathode chamber may be equipped with at least one inlet for adding aerated wastewater from the cathode chamber and at least one outlet for recovering the treated aerated wastewater from the cathode chamber. In the cathode chamber, the inlet(s) may be the same as the outlet.

The volume and number of the chambers are not limited. If the device comprises multiple anode chambers and multiple cathode chambers, the anode chambers may be connected directly to each other to let the wastewater movable among the anode chambers; and the cathode chambers may be connected directly to each other to let the wastewater movable among the cathode chambers.

The anode chamber may be connected to the cathode chamber in such a way that ions, especially anions, are allowed to move between the anode chamber and the cathode chamber. In one embodiment, the anode chamber may be connected to the cathode chamber via a separator, such as ion exchange membranes but not exclude others, preferably via anion exchange membrane. The anion exchange membrane allows anions transmissible between chambers, while the anion exchange membranes don’t allow cations such as NH₄⁺ transmissible.

The anode chamber may be used for treating the raw wastewater. The anode chamber may be inoculated with activated sludge or the raw wastewater as an inoculum which comprises electrogenic bacteria. As a result, the anode chambers may comprise the electrogenic bacteria, preferably on the surface of the anode(s). The electrogenic bacteria, or exoelectrogens, are a group of microorganisms that, under anaerobic or microaerobic conditions, can transfer electrons extracellularly across the cell envelope to or from electron acceptors including electrodes, oxide minerals, and other bacteria. The electrogenic bacteria can degrade organic compounds in raw wastewater to produce CO₂ and electrons and provide the anode(s) with the produced electrons. The electrogenic bacteria may be autotrophic bacteria, and include, but are not limited to, species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus and Ralstonia. Further examples of electrogenic bacteria include Escherichia, Methanospirillum, Rohdobactor, and Stenotrophomonas.

The cathode chambers may be used for denitrification. The cathode chamber may be inoculated with activated sludge or the aerated wastewater as an inoculum which comprises denitrifying bacteria. As a result, the cathode chambers may comprise denitrifying bacteria, preferably on the surface of the cathode(s). The denitrifying bacteria can perform denitrification as part of the nitrogen cycle and metabolize nitrogenous compounds using various enzymes, turning nitrate and nitrite (NO₃⁻, NO₂⁻) back to nitrogen gas (N₂) or nitric oxide, nitrous oxide (NO, N₂O), preferably by using the electrons which were produced by the electrogenic bacteria and provided through the anode(s), a means for applying and/or adjusting potential and the cathode(s). Preferably, the denitrifying bacteria reduces nitrates (NO₃⁻), and nitrites (NO₂⁻) all the way to nitrogen gas (N₂). The denitrifying bacteria may be autotrophic bacteria and include, but are not limited to, species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, and Maribacter. Further examples of denitrifying bacteria include Janthinobacterium, Hyphomicrobium, Mesorhizobium, Methylobacillus, and Rhodobacter, Rhodopseudomonas.

In one embodiment, the cathode chamber and/or anode chamber may further comprise inside reference electrode(s). It is preferable that when potential is applied either to the cathode or the anode, it is adjusted by using the reference electrode(s).

In one embodiment, the anode and/or cathode is preferably resistant to corrosion caused by wastewater. The anode and/or cathode may be conductive electrodes, preferably carbon fiber electrode or stainless steel.

In one embodiment, the cathode chamber and/or anode chamber further may comprise inside a means for stirring inside the chamber continuously or periodically. The means may include, but is not limited to, a stirring pump, bubbling machine and the like. The means may be the shape or structure per se of the chambers.

In one embodiment, the present application includes a system comprising a device as stated above and a means for adjusting potential. The potential may be adjusted either to the cathode or the anode versus the reference electrode, or adjusted between the anode and the cathode. The means may possess function for applying potential. The means includes, but is not limited to, a potentiostat, external resistor and open circuit potential. In some embodiments, the external resistor may have a resistance of 100 Ω ~1000 Ω. The term “open circuit potential” corresponds to the use of a resistor with infinite or near-infinite resistance, such as when the terminal ends of a circuit are detached or when there is no external load between electrodes.

In one embodiment, the present application includes
a method for eliminating organic compounds such as organics, suspended solids and volatile fatty acids from raw wastewater containing the organic compounds;
a method for removing nitrate and/or nitrite from aerated wastewater comprising the nitrate and/or nitrite;
a method for removing phosphate from aerated wastewater comprising the phosphate;
a method simultaneously for eliminating organic compounds such as organics, suspended solids and volatile fatty acids from raw wastewater comprising the organic compounds and for removing nitrate and/or nitrite from aerated wastewater comprising the nitrate and/or nitrite; and
a method for simultaneously performing
anaerobiotic elimination of organic compounds such as organics, suspended solids and volatile fatty acids, and pathogens from raw wastewater comprising electrogenic bacteria and the organic compounds, and removal of nitrate and/or nitrite and phosphate from aerated wastewater comprising denitrifying bacteria and the nitrate and/or nitrite and phosphate.

The methods may comprise:
1) a step of adding the raw wastewater into the anode chamber of a device as stated above and adding the aerated wastewater into cathode chamber of the device; and then
2) a step of adjusting potential either to the cathode or the anode (preferably versus the reference electrode), wherein “adjusting potential” may comprise “applying potential”.

In the anode chamber, the electrogenic bacteria may degrade the organic compounds and provide electrons with the anode connected to the means for applying and/or adjusting potential.

In the cathode chamber, the denitrifying bacteria may receive the electrons via the cathode and reduce the nitrate and/or nitrite, with the electrons, preferably converting into NO, N₂O and/or N₂ gas. Salts of the phosphate such as calcium phosphate may be precipitated in the cathode chamber if the wastewater comprises phosphate.

In one embodiment, the raw wastewater to be added into the anode chamber may be livestock wastewater or supernatant thereof, preferably swine wastewater or supernatant thereof. In particular, the raw wastewater may be preferably a wastewater which was applied to any precipitation treatment and obtained by removal of any debris and/or solids, but still contains rich organic compounds (for example, at 1000 mg/L ~ 10000 mg/L of COD value, more preferably at 1000 mg/L ~ 3000 mg/L of COD value). The raw wastewater may comprise living electrogenic bacteria.

The aerated wastewater may be an aerated livestock wastewater or supernatant thereof, preferably aerated swine wastewater or supernatant thereof. The aerated wastewater may be aerated wastewater which was applied to any precipitation treatment and obtained by removal of any debris and/or solids. In particular, the aerated wastewater may contain rich nitrate and/or nitrite, for example, at 100 or more mg/L (NO₃⁻-N), at 200 or more mg/L (NO₃⁻-N) or at 100 to 400 mg/L (NO₃⁻-N). Further, the aerated wastewater may also be low in organic compounds (for example, at 5 ~ 30, but not limited, of BOD value). Accordingly, the ratio of BOD/N of the aerated wastewater can be 3 or less, 2 or less, 1 or less, 0.5 or less, 0.2 or less, or 0.1 or less. The aerated wastewater may comprise living denitrifying bacteria.

In another embodiment, the raw wastewater treated in the anode chamber may be used as a source of the aerated wastewater. In that case, the raw wastewater may preferably comprise the organic compounds as well as NH₄⁺. The raw wastewater treated in the anode chambers is recovered and applied to an aeration treatment where the NH₄⁺ is converted into NO₃⁻ and/or NO₂⁻ by nitrifying bacteria. If necessary, the aerated wastewater may be further applied to any precipitation treatment in order to remove any debris and/or solids. The treated wastewater derived from the raw wastewater may be available as aerated wastewater to be added into the cathode chamber. Therefore, the device to be used may be connected to an aeration tank via the inlets. The connection enables the raw wastewater treated in the anode chamber to flow into the aeration tank, and the treated raw wastewater to be converted into the aerated wastewater by aeration in the aeration tank, and the aerated wastewater to flow into the cathode chamber.

The nitrifying bacteria get their energy by the oxidation of inorganic nitrogen compounds. The nitrifying bacteria may be autotrophic bacteria and include, but are not limited to, species of the genera e.g. Nitrosomonas, Nitrosococcus, Nitrobacter, Nitrospina, Nitrospira and Nitrococcus.

In case of using the potentiostat as the means for adjusting potential, the cathode may poise, approximately or on an average, -0.1 to -1 V, preferably -0.2 to -0.8 V, more preferably -0.4 to -0.6 V vs (Ag/AgCl), at step 2). The potential can enhance enrichment of denitrifying bacteria on the cathode.

At least step 2) may be performed at the anaerobic condition, when the bacteria in the anode chamber and cathode chamber are anaerobic bacteria. Further, the method may be performed at ambient temperature (i.e., at 10 - 35° C., preferably at 20 - 30° C., or more preferably 22 -28° C., or at about 25° C.).

In addition of the raw wastewater, activated sludge comprising living bacteria (containing but not limited to, electrogenic bacteria, nitrifying bacteria and denitrifying bacteria) may be added in the anode chamber, at an amount of 0% to 60%, preferably at an amount of 20% to 25% capacity of the anode chamber.

In addition of the aerated wastewater, activated sludge comprising living bacteria (containing but not limited to electrogenic bacteria, nitrifying bacteria and denitrifying bacteria) may be added in the cathode chamber, at an amount of 0% to 60%, preferably at an amount of 20% to 25% capacity of the cathode chamber.

The activated sludge may be added before the step 2). The activated sludge may be added before, concurrently with or after adding the wastewater.

The above method can provide the aerated wastewater after the step 2 comprising total 100 mg/L or less, 50 mg/L or less, or 10 mg or less of NO₃- and NO₂- as nitrogen equivalent.

The above methods can provide the raw wastewater after the step 2 comprising organic compounds removed to 100 mg/L ~ 1000 mg/L or 1000 mg/L or more of COD value.

The above method can perform that more than 30%, more than 40%, more than 50%, or more than 60% of phosphate phosphorus present in the aerated wastewater is removed by step 2) in terms of the amount by weight of phosphorus.

### EXAMPLES

The invention will be described in more detail in the following Examples. Meanwhile, the invention is not limited to these Examples. In these Examples, herein, experiments using commercially available kits and reagents were done according to attached protocols, unless otherwise stated. The present invention will now be demonstrated by the following nonlimiting examples.

### Example 1

### Material and Methods

### 1. BES Design and Construction

Double-chambered BESs were fabricated using transparent poly-acrylic sheets. To provide high surface areas for bacterial growth, two carbon brush electrodes with carbon fiber ZOLTEK Panex 35 density 800 K tips per 2.5 cm containing two pieces of stainless steel wire 3.5 mm in diameter (Hengshui Chiehwang Industry and Trade Co, China) with a length of 10 cm were used for both anodes and cathodes. Prior to initial use, the brushes were soaked in acetone overnight, heated at 450° C. for 30 min in a muffle furnace (Feng et al., 2010) and washed three times with distilled water. The distance between the anode and cathode electrodes was 2 cm. A Nafion™ 117 (Dupont, USA) membrane was used as a cation exchange membrane (CEM) between the anode and cathode chambers, and an AMI-7001 (Membranes International Inc., USA) was used as an anion exchange membrane (AEM). Two membrane frames were installed with a surface area of 48 cm². The electrodes were connected to a potentiostat (Uniscan PG580RM) using a titanium wire. All experiments were carried out in a three-electrode setup or open circuit potential. The cathodic and anodic compartments were each 1 L. The system was run under a controlled temperature of 25° C.

### 2. Inoculation, Enrichment and Operation of the System

Both swine wastewaters (raw and aerated) and activated sludge from the aeration tank were obtained from Okinawa Prefecture Livestock and Grassland Research Center, Japan. Both anode and cathode chambers were inoculated with activated sludge with an initial ratio to wastewater streams of 1:3. Following inoculation, the anode chamber was then filled with full-strength raw swine wastewater, whereas the cathode chamber was filled with wastewater after aeration treatment. The chemical compositions of the two types of wastewater in comparison with the same wastewater after treatment in BES are shown in Table 1. Before being fed into the BES, wastewater was passed through a mesh with 1 mm pore size to remove any remaining sludge particles. The average initial pH for wastewater used in the anode chamber was 6.86 ± 0.26 with a conductivity of 263 ± 28 µS cm⁻¹. The average initial pH for wastewater after aeration used in the cathode chamber was 7.96 ± 0.34 with a conductivity of 315.5 ± 8.5 µS cm⁻¹. The nitrate-nitrogen level of the wastewater used in the cathode chamber was adjusted to 300 mg L⁻¹ by sodium nitrate. During all the experiments both chambers were maintained under anaerobic conditions and were operated in a fed-batch mode.

### 3. BES Operation

All experiments were carried out in a three-electrode setup or open circuit potential, where the cathode was used as a working electrode controlled chronoamperometrically and the Ag/AgCl electrode was used as a reference electrode (0.197 V vs. standard hydrogen electrode, Radiometer XR300 Reference Electrode, Hach). After inoculation, BESs were pre-incubated under open circuit potential (OCP) to allow a bacterial biofilm to acclimatize to the environment. An overview of the three stages of the experimental runs tested in Example are shown in Table 2.

In Stage I, nitrate removal and the obtained end-product were evaluated under the following conditions: different applied cathodic potentials (-0.2 V, -0.4 V and -0.6 V vs. Ag/AgCl reference electrode), open circuit potential (OCP), and reactors without inoculum with an applied potential of -0.6 V and reactors without electrodes. In Stage II and III, BESs were run under the applied potential of -0.6 V and OCP mode. All BESs were run in duplicates. For experiments in Stage III, BESs were operated for 180 days to examine their performance and to analyze how the microbial communities adapted over time. Cell voltages during the open circuit (OCP) mode were monitored with a data logger (GRAPHTEC Midi Logger GL240).

$$\text{CE} = \frac{t \int I d t}{V F n Δ N {O}_{3}}$$

Coulombic efficiency was calculated based on the following equation: where F is a Faraday constant (F= 96485 C mol⁻¹ e⁻), V is the cathode liquid volume, n represents the number of electrons spent for this reaction (5 e⁻ for denitrification process) and ΔNO₃ shows how much nitrate-nitrogen (NO₃⁻-N) was consumed in mmol N L⁻¹ h⁻¹.

### 4. Chemical Analysis

The concentrations of chemical oxygen demand (COD), volatile fatty acids (VFA), ammonium (NH₄⁺ -N), nitrate (NO₃⁻-N) and nitrite (NO₂⁻-N) were analyzed using HACH test kits (USA). All samples prior to measurement (except COD) were filtered through 0.45 µm filters. The pH and conductivity were measured with a pH-meter (LAQUAtwin-pH-33, Horiba scientific, Japan) and EC-meter (LAQUAtwin-EC-33, Horiba Scientific, Japan).

N₂O in liquid phase was analyzed using gas chromatography mass spectrometry (PEGASUS 4D GCxGC-TOFMS, LECO, MI, USA) equipped with a PLOT column particle trap (0.25 mm x 2.5 m, GL Science, Tokyo, Japan) and RT-Q-BOND separation column (0.25 mm x 30 m, 8 µm, RESTEK, PA, USA).

Suspended solids (SS) was measured according to the Environmental Standards for Water Pollution method (Japan) Appendix 9.

### 5. Microbiological Analysis

Biofilm samples were collected from both cathodic electrodes after seven days in Stage I, and after cycle #45 at day 180 in Stage III, when microbial communities stabilized. Genomic DNA was extracted from the solid samples using the Maxwell RSC DNA kit (Promega, USA). RNA was extracted using the Maxwell RSC RNA kit (Promega, USA). Quality of the extracted DNA and RNA was analysed using the 4200 TapeStation (Agilent, USA). For DNA shotgun sequencing NEBNext Ultra™ II FS DNA Library Prep Kit for Illumina was used and sequencing was done on NovaSeq6000 (Illumina). For ribosomal RNA removal Ribo-Zero rRNA Removal Kit (Bacteria) was used. Libraries were prepared using a NEBNext Ultra II Directional RNA Library Prep Kit for Illumina and sequencing was done on NovaSeq6000 and HiSeq2500 Rapid (Illumina). Coliform bacteria was counted in accordance with the Japanese Industry Standard K 0350-20-10 : 2001 method.

For the scanning electron microscopy (SEM) analysis, small pieces of cathode electrodes with biofilm were taken from the BESs and immersed in 2.5% (w/v) glutaraldehyde in a 0.1 M cacodylate buffer at pH 7.4. Thereafter, samples were washed and dehydrated successively in an ethanol series. The fixed samples were dried with a critical-point drier and sputtered with a gold layer. The coated samples were examined with the SEM (JEOL JSM-7900F) at 15kV and the images were captured digitally.

### 6. Sequencing and Data Analysis

Combined taxonomic domain information analysis was conducted with the MG-RAST (Meta Genome Rapid Annotation using Subsystem Technology) server under the following conditions: taxonomy domain filters were set for Bacteria and Archaea, %-identity was set to 90%, length was set at 50; all other parameters were set as the default values.

The bar plot and heatmap illustrating genomic abundances were generated using the ggplot2 package (Wickham, 2016) within R (R Core Team, 2013). The data for the plot was exported as a tsv file using the RefSeq database within MG-RAST.

TABLE 1

Chemical analysis of raw full-strength and aerated wastewater in comparison with wastewater after treatment in BES in Stage I.

| | Anode chamber | | Cathode chamber | |
|---|---|---|---|---|
| Parameter | Raw wastewater | Raw wastewater after BES | Aerated wastewater | Aerated wastewater after BES |
| pH | 6.9 ± 0.3 | 7.0 ± 0.5 | 7.6 ± 0.3 | 8.0 ± 0.3 |
| *EC (mS m⁻¹) | 263 ± 28 | 255 ± 25 | 316 ± 9 | 289 ± 31 |
| CODcr (mg L⁻¹) | 5750 ± 1750 | 408 ± 92 | 275 ± 165 | 120 ± 20 |
| NO₃⁻-N (mg L⁻¹) | < 1.0 | 6.5 ± 2.0 | 245.0 ± 35.0 | 7.9 ± 4.8 |
| NO₂⁻-N (mg L⁻¹) | < 0.02 | 0.15 ± 0.02 | 0.24 ± 0.20 | 0.16 ± 0.03 |
| NH₄⁺-N (mg L⁻¹) | 287 ± 82 | 10 ± 1 | 2.2 ± 2 | 13 ± 9 |
| SS (mg L⁻¹) | 2.30 ± 0.30 x | 0.03 ± 0.02 x | 0.04 ± 0.01 x 10³ | 0.01 ± 0.01 x |
| Coliform (CFU | 10³ | 10³ | 2.2 ± 1 × 10³ | 10³ |
| cm⁻³) | 2.5 ± 2 x 10⁶ | < 1.0 | | < 1.0 |

TABLE 2

Overview of the stages of experimental runs.

| Stage # | Applied potential (V) | Control conditions | Duration (days) | Type of membrane |
|---|---|---|---|---|
| Stage I | -0.6, -0.4, -0.2 | OCP, no inoculum, no electrodes | 7 | Cation |
| Stage II | -0.6 | OCP | 11 | Cation and anion |
| Stage III | -0.6 | OCP | 180 | Anion |

TABLE 3

COD and VFA removal under different electrochemical conditions in the anode chamber.

| Conditions | COD degradation efficiency (%) | VFA degradation efficiency (%) |
|---|---|---|
| Applied -0.6 V | 55.9 ± 3.5 | 32.1 ± 0.4 |
| Applied -0.4 V | 61.4 ± 0.5 | 39.7 ± 6.2 |
| Applied -0.2 V | 58.1 ± 3.1 | 41.5 ± 8.3 |
| OCP | 58.6 ± 1.5 | 21.8 ± 3.2 |
| No inoculum (-0.6 V) | 38.5 ± 2.1 | 18.0 ± 1.6 |

* Initial concentration of COD was 5.2 ± 0.2 g and initial concentration of VFA was 1.4 ± 0.2 g.

### Results

### 1. Overall Performance of Denitrifying BES for Concurrent Treatment

### 1.1 Biocathodic Denitrification in BES Under Different Electrochemical Conditions (Stage I)

A 2 L biocathodic BES was constructed to treat raw full-strength wastewater containing high organic and volatile fatty acid levels in the anode chamber and treated wastewater after aeration in the cathode chamber. In the cathode chamber, where BOD can be less than 10 mg L⁻¹, nitrate was reduced to nitrite, nitrous oxide and to nitrogen gas by denitrification via the cathodic microbial community.

Stage I demonstrated the significance of the applied potential at the cathode for the rate of nitrate removal. Influence of the applied potentials on NO₃⁻-N removal in a fed-batch mode during the experimental period of seven days is shown in FIG. 1A. An initial NO₃⁻-N concentration of 300 mgL⁻¹ was set based on the highest value at local farms. This initial concentration was almost completely removed in BESs under the applied potential of -0.6 V after seven days and amount of removed NO₃⁻-N was 282 ± 12 mg L⁻¹. The applied cathodic potential of -0.6 V showed the best removal compared to -0.4 V and -0.2 V (226 ± 21 mg L⁻¹ and 213 ± 19 mg L⁻¹ NO₃⁻-N under the applied potential of -0.4 V and -0.2 V, respectively). Also, the amount of removed nitrate under OCP was significantly lower in comparison with applied potential conditions (145 ± 13 mg L⁻¹ NO₃⁻-N). Other control conditions with no electrodes BES and no inoculum BES also showed low removal ability (82 ± 7 mg L⁻¹ and 87 ± 11 mg L⁻¹ NO₃⁻-N, respectively). These results indicate the significance of applied potential, and presence of an inoculum, for faster denitrification. This is likely due to the enrichment of microbial communities under these conditions.

FIG. 1B demonstrates the current responses over time in reactors under different applied potentials (-0.6 V, -0.4 V and -0.2 V). A drop in the cathodic current indicated an active electrochemical reduction process, by which denitrification could proceed with the help of electrotrophic denitrifying bacteria, as reported previously (Chen et al., 2017). FIGS. 1A and 1B show the clear correlation between nitrate removal and cathodic potentials: a lower cathodic potential leads to a higher nitrate removal rate. This correlation is in accord with a previous report (Yu et al., 2015). When more nitrate was removed, it resulted in a rapid decrease of the cathodic current, which reflected the consumption of electrons donated for denitrification by the cathode. The subsequent increase of the cathodic current was caused by decreasing nitrate concentrations due to the limited amount of nitrate available in the fed-batch mode. The cathodic coulombic efficiency for nitrate reduction exceeded 100% under all applied potential conditions (data not shown). These high values indicate that heterotrophic denitrification using the organic substrate in the BES as the electron donor may also contribute to the rate of nitrate removal.

Nitrite as the intermediate product of denitrification was detected on day 1 of the experiment, where it increased until day 2, at which point it decreased as the enrichment time period progressed (FIG. 1C). This indicates that nitrate reduction to nitrite took place at the cathode at day 1 and 2, when the denitrification process has just started. Thereafter nitrite was bioelectrochemically reduced through the next steps of denitrification, i.e. NO,

N₂O to N₂, by the cathodic microbial community which was consistent with a previous report (Puig et al., 2011). Moreover at day 1 and 2 ammonium flux from the anode chamber through the membrane to the cathode chamber was detected (FIG. 1D), which might be oxidized to nitrite during this time (See section 3.4.1). Under electrochemically stimulated conditions higher concentrations of nitrite were detected (25 - 46.7 mg L⁻¹ NO₂⁻-N) in comparison with the control BESs (2 - 12 mg L⁻¹ NO₂⁻-N) that is in line with the faster nitrate removal under applied potentials. GC/MS analysis revealed that only minor concentrations of N₂O, a potent greenhouse gas, were detected (data not shown), which suggests that the denitrification cycle likely completed with the release of nitrogen.

Consumption of protons by the denitrification reactions in BES is likely responsible for the increase in alkalinity to pH 8.0, which is still in the optimal pH range for conventional denitrification (Sun et al., 2020).

Generally, these results show the potential advantages of a biocathodic denitrification system using aerated wastewater coupled with the simultaneous treatment of raw wastewater with a controlled delivery of electrons. Moreover, this study demonstrates the importance of using sludge as an inoculum. In a previous study, Khilyas et al. (Khilyas et al., 2017) compared different types of sludge as an inoculum to treat swine wastewater and found that sludge taken from the same aeration tank performed better as a microbial fuel cell anodic inoculum than a brewery treatment sludge. In addition, high electron-utilization efficiency, low sludge production and easy handling are all promising features for nitrate removal using livestock wastewater for a large-scale reactor.

### 1.2. Treatment of a Raw Swine Wastewater in the Anode Chamber

During these experiments, COD and VFA removal in the anode chamber were constantly monitored (Table 3). Under conditions with applied cathodic potentials and OCP mode, COD consumption rates were similar (around 0.87 ± 0.07 g COD L⁻¹ d⁻¹), with the highest removal of 1.62 g L⁻¹ d⁻¹ ± 0.03 g L⁻¹ d⁻¹ at first day. The total average efficiency under these conditions was 58.5 ± 2.6%, where the highest was achieved at -0.4 V (61.4 ± 0.5%), although there was no statistically difference within BESs under applied potentials and OCP mode (data not shown). This may indicate that applied potential at cathode is not influencing COD removal rate significantly in the anode chamber in this system. Similar COD removal rate of 1.6 ± 0.7 g COD L⁻¹ d⁻¹ and 2.1 ± 0.5 g COD L⁻¹ d⁻¹ was reported previously (Vilajeliu-Pons et al., 2017), where swine manure was treated in six-stacked microbial fuel cells (MFC) with a continuous mode. These results show that denitrifying BES could achieve similar treatment rates as MFC, which is specifically design to treat organic matter. Meanwhile in reactors without inoculum (sludge) under the applied potential of -0.6 V, the COD removal rate was 0.53 g L⁻¹ d⁻¹ ± 0.21 g L⁻¹ d⁻¹ with an efficiency of 38.5 ± 2.1%. The result indicated the importance of sludge from the aeration tank as an initial bacterial inoculum and contributed the faster enrichment of communities.

Best VFA removal was detected with applied potentials of -0.2 V and -0.4 V with an efficiency of 41.5 ± 8.3% and 39.7 ± 6.2% respectively. The highest removal rate of 486 ± 18.5 mg VFA L⁻ ¹ d¹ was performed at -0.2 V. That indicates that activity of electrogenic community reached maximum at -0.2 V applied to cathode, because in this case cell voltage of BES stabilized at 0.13 ± 0.05 V (data not shown), meaning that anode potential was 0.33 ± 0.05 V. It was shown previously, that electrogenic community operated at maximum electron transfer rates when anode potentials were higher than 0.2 V vs. Ag/AgCl reference electrode (Prokhorova et al., 2017), leading to the higher rates of VFA removal. Under the other tested conditions potential at anodes did not exceed values of 0.2 V.

To investigate further the quality of the wastewater after BES treatment in the anode chamber, a coliform bacteria test, which is usually used as an indicator of the pathogenic or fecal contamination of the water, was performed. After seven days of the experimental run a more than 1000-fold reduction in coliform density was confirmed (data not shown). This suggests that treatment in BES could suppress pathogenic bacteria in wastewater. It is in a line with the previous findings that BES could disinfect wastewater enriched in Enterobacteriaceae (Shigella, Yersinia, Vibrio) (Vasieva et al., 2019). Further experiments are needed to understand whether different potentials at anodes influence reduction in coliform density. Moreover, suspended solids (SS) concentrations were also removed from the wastewater with an efficiency of 89% (Table 1).

### 2. Optimization of Nitrate Removal in BES (Stage II)

As a result of ion migration through the cation exchange membrane (CEM), the transport of ammonium from the anode chamber to the cathode chamber was detected with a maximum concentration of 162.5 ± 7.5 mg NH₄⁺-N L⁻¹ (FIG. 1D). Accumulation of ammonium increased the total nitrogen concentration in the cathodic chamber. In order to overcome this limiting factor, the CEM was replaced with an anion exchange membrane (AEM) in Stage II of the experimental run. Total initial amount of 300 mg L⁻¹ NO₃⁻-N was completely removed within 5 days (with maximum of 99 ± 2 mg NO₃⁻-N L⁻¹d⁻¹) in AEM reactors, while in CEM reactors it took around 8-9 days (with maximum of 34 mg L ⁻¹d⁻¹± 7 mg L⁻¹ d⁻¹), when -0.6 V was applied (FIG. 2A).

Overall, a BES with an AEM also achieved better organic removal in the anode chamber (0.8 g COD L⁻¹ d⁻¹), where only a negligible amount of nitrate (~1.1 mg NO₃⁻-N L⁻¹) was detected. This indicated that either only a minor amount of diffusion could happen, or nitrate that migrated through the AEM was reduced to nitrogen gas by denitrifying bacteria in the anode chamber. This is consistent with previous research based on swine wastewater (Vilajeliu-Pons et al. 2015). In Stage II of the experimental run, there was only a slight increase of ammonium observed in the cathode chamber (~3.8 mg L⁻¹ ± 2.2 mg NH₄⁺-N L⁻¹ d⁻¹).

### 3. Adaptability for a Long-Term Run (Stage III)

At present, little is known about the long-term adaptation of electrotrophic denitrifying bacteria and the efficiency of denitrification over time using real livestock wastewater. In Stage III of the current study, long-term denitrification with a focus on stability and enrichment of denitrifying bacteria were investigated. BES with AEM were operated for 45 cycles, with each cycle having a hydraulic retention time (HRT) of three days. At every odd cycle number wastewater was changed in both chambers (the anode was filled with untreated wastewater and the cathode with aerated wastewater). At every even cycle number only the cathode chamber was filled with a new batch of aerated wastewater. BESs were run under the applied potential of -0.6 V and the OCP mode, that was used as a control. The first 10 cycles of operation demonstrated high nitrate removal rates: 90 mg L⁻¹ d⁻¹ (under the applied potential conditions). As the absorption of nitrate by the anion exchange membrane was confirmed (data not shown), the initial high removal rate might be due to membrane absorption together with the denitrification process. After 10 cycles, the nitrate removal rate stabilized at an average value of 60 mg NO₃⁻-N L⁻¹ d⁻¹ (with the highest value being 78 mg NO₃⁻-N L⁻¹ d⁻¹). These results show an increase in nitrate removal efficiency during long-term performance in comparison with previous research (Gregoire et al., 2014; Tang et al., 2017). Once stabilized, the removal efficiency of every odd cycle (both anodic and cathodic wastewater were changed) and even cycle (only cathodic wastewater was changed and run with lower organics in the anode chamber) were compared (FIG. 3). The average value of reduced nitrate in three days was significantly higher in the odd cycles (198 ± 51 mg L⁻¹ under potential of -0.6 V and 160 ± 42 mg L⁻¹ under OCP) compared to the even cycles (177.2 ± 58 mg L⁻¹, under potential of -0.6 V and 133.8 ± 56 mg L⁻¹ under OCP), indicating the importance of anode organics as an electron source for faster nitrate removal.

Moreover, the significant reduction in nitrate concentration agreed with the distinct current consumption (FIG. 4). The current at initial cycles tended to have larger peak values on the first day, after the wastewater was changed, and then gradually decreased as nitrate was reduced (FIG. 4A, B). Following the longer operation time, the current was stabilized regardless of wastewater change (FIG. 4C). This effect might be attributed to the rapid consumption of electrons by denitrifying bacteria supplied by the cathode.

Taken together, our results suggest that cathodic denitrification in a BES with an AEM has a very promising removal rate using real wastewater. Our long-term experimental run promoted the growth of desired denitrifying bacteria that exhibited good electrochemical activity, leading to the higher nitrate reduction rates that were observed.

To enable the feasibility of scale-up for pig farms, we are developing reactors with less costly components, lower maintenance needs and proper microbial community stability over long-term operation.

### 4. Bacterial Community Structure

Taxonomic compositions of the microbial communities occupying cathodes from the experiments in Stage I with a CEM (under the applied potentials of -0.6 V and -0.2 V, OCP and no electrodes) and from the experiments in Stage III with an AEM (under the applied potential of -0.6 V and OCP mode after operating over six months) were evaluated in comparison with the original communities from an activated sludge using a shotgun metagenome sequencing approach (FIG. 5). In Stage I, the influence of the different electrochemical conditions on cathodic microbial community was examined. Later in Stage III, the main aim was to investigate the adaptation of the established electrotrophic and denitrifying microbial community on the cathodes after six months. About 800,000 sequences were obtained under each condition. Genera at relative abundances higher than 1% were considered to comprise the core community. Taxonomic distributions of samples were analyzed from the levels of genus to species.

### 4.1. Comparative Analysis of the Microbial Community Under Different Electrochemical Conditions

Activated sludge, as an inoculum, represent the initial bacterial community and was mainly domintaed by Thauera (31.7%) and Azoarcus (4.3%) in the family Zoogloeaceae together with Acidovorax spp. (10.3%) in the family Comamonadaceae and Mycobacterium spp. (5.9%) in the family Mycobacteriaceae. Previously, two specific families, Zoogloeaceae and Comamonadaceae, were identified in activated sludge as being mainly involved in the denitrification process (Khan et al., 2002). Also, Thauera and Azoarcus were shown to account for as much as 16% of all living bacteria in the activated sludge (Juretschko et al., 2002). During the operation of the BES, the bacterial community had changed from a heterotrophic anaerobe-dominated community to an anaerobic community with diverse metabolic pathways, including both heterotrophs and autotrophs. In samples from the experiments in Stage I, microbial diversity and their functions varied depending on the applied electrochemical conditions. Significant change in taxonomic distribution was observed under conditions with the applied potential of -0.6 V, by which the fastest rate of denitrification was recorded. The most abundant bacteria belonged to the Pseudomonas genus (21.7%), which represent contains various denitrifying and exoelectrogenic bacteria (Deng et al., 2020; Vo et al., 2020). It was also shown by Deng et al. (2020) that in a MFC-granular sludge coupling system, denitrification was mainly carried out by the highly dominant Pseudomonas (14.79%) and Thauera (26.21%) spp.. Although Thauera had the highest relative abundance in the activated sludge samples, in reactors under the OCP mode (22.6%) and also under a potential of -0.2 V (26.6%), their abundance decreased to 9.8% under a potential of -0.6 V. This is a heterotrophic facultative anaerobic and obligate respiratory bacteria that can use nitrate and nitrite as an electron acceptor (Deng et al., 2020; Yang et al., 2019).

Instead the dominance of heterotrophic Thauera, the community was additionally enriched with the autotrophic denitrifying bacteria genera Sideroxydans (9.9%) and Galionella (8.6%), which have the potential ability to accept electrons from the electrode. Both are adapted for chemolithoautotrophy, including pathways for CO₂-fixation and electron transport pathways for growth on Fe(II) at low O₂-levels (Emerson et al., 2013). Their ability to oxidize extracellular Fe(II) is based on a specific pili structure and cytochrome sets that allow these bacteria to accept electrons from the cathode and transport them to nitrate (Emerson et al., 2013). The main differences between these bacteria include the ability of Sideroxydans to grow on reduced S-compounds and fix nitrogen. On the other hand, Galionella is more tolerant to the presence of heavy metals (Fabisch et al., 2013), which may be common in livestock wastewater treatment environments (Irshad et al., 2013). Interestingly, the nitrite reductase/nitric oxide reductase operon of Sideroxydans is nearly identical to that of Acidovorax. Previous research confirmed that some Acidovorax spp. can grow by denitrification using inorganic electron donors such as Fe(II) (Chakraborty et al., 2011; Park et al., 2017), but our taxonomical composition analysis revealed that the abundance of Acidovorax decreased to 8.4% in reactors with the applied potential of -0.6 V. This might be due to their suppression by the dominant Pseudomonas spp.

Under the applied potential of -0.2 V, the core community was dominated by Thauera (26.6%), Nitrosomonas (12.4%), Thiobacillus (12%), Acidovorax (9.8%) and Pseudomonas (8.9%), all of which are involved in the nitrogen cycle. Nitrosomonas are the most well-known ammonia-oxidizing bacteria (Holmes et al., 2004) that may be electrochemically active and be able to accept electrons from the cathode electrode (Wang et al., 2013). In this study, where a CEM was used, the observed ammonium flux from the anode chamber to the cathode chamber (FIG. 1D) might have created the ideal conditions for the active growth of Nitrosomonas, which support the conversion of ammonium to nitrogen gas.

In the OCP mode, the core microbial community remained closely related to the original inoculum community, where the most dominant genera were: Thauera (22.6%), Acidovorax (11%) and Azoarcus (5.6%), but also with highly abundant Geobacter (19.9%). It was previously reported about the effective coexistence of exoelectrogenic Geobacter (6.5%) and denitrifying Thauera (59.9%) during a long-term operation in a single-chamber air cathode system with an external resistance of 1000 Ω (Huang et al., 2019). However, this syntrophic relationship is still under-studied and needs further investigation. In the current study, we observed that Geobacter was more abundant under the OCP mode than any other conditions. These results imply that OCP conditions may be associated with the ferric reduction process. All of the above indicate that the investigated biofilm that developed on the surface of the biocathode consisted of a very diverse microbial community, in which microorganisms with opposite functions (e.g., Fe³⁺ reducers/Fe²⁺ oxidizers) may coexist and interact on complementary processes. Although the relationship between species diversity and ecosystem functioning has been debated for decades, there is an emerging consensus that greater diversity enhances functional productivity and stability in communities of microorganisms (Tilman et al., 2014). The increased overall diversity of electrotrophic denitrifiers in reactors at -0.6 V relates to increased ecosystem function and stability in bacterial denitrifying communities with equivalent richness, thus improving BES performance for nitrate removal.

### 4.2. Cathodic Microbial Community After Long-Term Adaptation

It was of interest to investigate how such a community had changed during a long-term run conducted in a fed-batch mode. In Stage III, adaptation of the microbial communities on the cathodes under the applied potential of -0.6 V and OCP mode over six months were examined. To the best of our knowledge, this current work is the first study to investigate the pre-grown denitrifying biofilm in a fed-batch system using real wastewater in a long-term operational run. The microbial community after six months under the applied potential of -0.6 V at the cathode was mainly enriched by Thiobacillus (60.7%) (FIG. 5). These bacteria utilize the S from iron sulphide (FeS) as electron donor and oxygen as electron acceptor, with the S being oxidized to sulphate (SO₄²⁻). Some species from this genus can oxidize Fe²⁺ and use nitrate as an electron acceptor (Straub et al., 1996). Thiobacillus denitrificans has been reported as an electroactive denitrifying bacteria that can directly utilize a solid electrode as a sole electron donor and capable of enrichment on the cathode to promote denitrification (Pous et al., 2014; Yu et al., 2015). It was also reported previously that cathodic biofilms were dominated by Thiobacillus (75-80%) in BES, where a prior enriched inoculum was used (Pous et al., 2014). These results shows the importance of Thiobacillus for efficient and continuous denitrification process using a wastewater and its ability to create robust and stable biofilms on the electrodes.

Under the OCP mode, the major contributors were evenly distributed among the following bacteria: Thauera spp. (14.3%), Nitrospira (13.7%), Mycobacterium (10.6 %) and Acidovorax (8.2%). Interestingly, that Acidovorax (3.9%), Mycobacterium (2.9%) and Nitrospira (2.7%) were also found to be abundant next to Thiobacillus in the reactors under -0.6 V. Mycobacterium includes pathogens known to cause serious diseases in mammals and humans. This genus was previously found during autotrophic microbial denitrification (Broman et al., 2017). Decrease of their abundance might be likely associated with the ability of BES to disinfect as was previously reported by Vasieva et al. (Vasieva et al., 2019), but still require further investigation. Nitrospira is known to be a key player in nitrification as an aerobic chemolithoautotrophic nitrite-oxidizing bacterium (Mehrani et al., 2020). These results indicated that such bacteria are capable of developing physically stable and biologically active biofilms during long-term treatment, although under the electrically stimulated environment they are outcompeted by Thiobacillus as a major consumer of electrons on the electrode surface.

### 4.3. Cathodic Microbial Community at Species Level

Taxonomic distribution at the species level was further analyzed and the top 30 species were selected and a logarithmic scale heatmap was produced (FIG. 5B). In the short-term experiment (Stage I) two Pseudomonas species were found the most abundant under potential of -0.6 V: P. putida and P. aeruginosa. Both are pathogenic bacteria and very closely related. But P. aeruginosa under anaerobic conditions can perform complete denitrification with the excessive production of nitrite (Arat et al., 2015), while heavy metal resistant P.putida can achieve simultaneous nitrification and aerobic denitrification (Zhang et al., 2019). Chemolithoautotrophic bacteria Nitrosospira multiformis oxidizes ammonia to nitrite and assimilates CO₂ as the major carbon source was found mainly in BES with CEM, where ammonium flux to the cathode chamber was detected. Abundant presence of P. aeruginosa and N. multiformis at -0.6 V may explain increased concentration of NO₂⁻ in comparison with the other conditions. In line with the analysis at genus level, two most abundant autotrophic denitrifiers (Gallionella and Syderoxydans) were identified as Gallionella capsiferriformans and Sideroxydans lithotrophicus. Dechloromonas aromatica, another known denitrifier, which is able for enhanced N₂O production under salt or stressed conditions (Han et al., 2019). In long-term experiment (Stage III) Thiobacillus denitrificans was the most abundant strain, that is in line with our study at genus level. It is interesting to note that the growth of such bacteria as Sorangium cellulosum, known for its ability to inhibit the growth of partners (Li et al., 2013), was reduced under long-term operation.

SEM analysis was used to visualize the microbial composition structure of the enriched biofilm on the cathodes at -0.6 V (Supplementary material).

### 5. Analysis of Nitrogen Metabolism in Cathodic Biofilms

Further nitrogen cycle related processes, denitrification, nitrification, ammonification and nitrogen fixation, in each reactor were analyzed. Overall, denitrification had the highest hits among the four processes. To demonstrate the expression of denitrification genes during Stage I, the metatranscriptome was analyzed from samples under applied potential of -0.6 V and OCP mode as a control. The expression of six representative genes, napAB and narGHIfor nitrate reductase, nirS and nirK for nitrite reductase, norBC for nitric oxide reductase and nosZfor nitrous oxide reductase, were investigated to analyze bacterial species involved in each step of the denitrification process (FIG. 6). Considering the high microbial diversity, only gene abundance over 3% of total copies were counted. Depending on the different electrochemical conditions, bacteria involved in each step of the denitrification process varied. Among the two types of nitrate reductases, respiratory (NarGHI) and periplasmic (NapAB), the periplasmic nitrate reductase dominated the number of total reads per species.

High abundances of napAB genes in a strain most closely related to Thauera sp. MZ1T was only expressed under applied potential conditions (15.5%), whereas Azoarcus sp. BH72 (19.4% vs. 6.7% at OCP mode) and Bordetella petrii (12.4% vs. 6.7% at OCP mode) were found to be present in both conditions, but were significantly more abundant at -0.6 V. These results indicating on their ability to proceed the first step of denitrification electrotrophically. For respiratory nitrate reductase (NarGHI) Aromatoleum aromaticum was the most dominant species under applied potential (39%). Both A. aromaticum and T. denitrificans have enzymes to reduce all intermediates in denitrification process, although in the current study under some conditions the abundance of these strains were lower than 3%. Thauera sp., Acidovorax sp., Alicycliphilus denitrificans and Dechloromonas aromatica are also hosted all genes necessary for a complete denitrification and were captured in our study with the high abundance under applied potential conditions.

Two structurally different nitrite reductases are found among denitrifiers, although they both are never expressed in the same cell (Zumft, 1997): one contains copper (Cu-Nir) encoded by the nirK gene and one contains heme c and heme d1 (cd1-Nir) encoded by the nirS gene. T. denitrificans and Burkholderia pseudomallei are two major sources of the nirSK genes in the samples at -0.6 V, while A. aromaticum and the Thauera sp. were dominant under the OCP mode. However, the abundances of nirSK genes hosted in P. putida (4%) and S. lithotrophicus (6.1%) were identified only in conditions with applied potential. This is in line with our previous finding in section 3.4.1, where microbial community in BES at -0.6 V were dominated by these autotrophic bacteria. Also it was proved on a transcriptomical level the dominance of Thauera under OCP conditions: the expression of nitrite reductases (nirSK), nitric oxide reductases (norBC) and nitrous oxide reductases (nosZ) were clearly dominated by species closely related to Thauera sp. MZ1T.

Nitric oxide reductase has two subunits, NorC and NorB, where NorC as a c-type cytochrome receives electrons from a periplasmic donor and passes them to NorB, which contains two b-type hemes and a non-heme iron (Vaccaro et al., 2015). Potential electrotrophic denitrifiers were identified at this denitirification step in BES at -0.6 V that are closely related to the following species: Maribacter sp. HTCC2170 (10.3%), Methylococcus capsulatus (8.1%), Roseobacter denitrificans (3.7%) and Dechloromonas aromatica (3.7%). However, further investigation of the enriched potential electrotrophs is needed. Meanwhile, under the OCP mode, norBCwas mainly presented by the Thauera sp. (20.9% vs. 5.9% under the applied potential) and T. denitrificans (14% vs. 11% under the applied potential). The last steps of denitrification are completed by catalysis of a soluble periplasmic Cu-containing the N₂O reductase nosZ. Of note, bacterial composition with norBC and nosZ genes are highly diverse in samples under the applied potential and OCP. This indicates that such conditions are conducive to the last two steps of the denitrification process.

In one embodiment of the present application, enhanced nitrate removal in the cathode chamber of bioelectrochemical systems (BES) using aerated swine wastewater under high nitrate levels and low organic carbon was investigated, focusing on the relationship between nitrogen and bacterial communities involved in denitrification pathways. As a result, BESs with the anion exchange membrane (AEM) under cathodic applied potentials of - 0.6 V vs. AgCl/AgCl reference electrode showed a removal rate of 99 ± 2 mg L^{- 1} d⁻ ¹. Moreover, organic compounds from the untreated full-strength wastewater were simultaneously eliminated in the anode chamber with a removal rate of 0.46 g COD L⁻¹ d⁻ ¹ with achieved efficiency of 61.4 ± 0.5% from an initial concentration of around 5 g of COD L⁻ ¹, measured over the course of 7 days. The highest microbial diversity was detected in BESs under potentials of - 0.6 V, which include autotrophic denitrifiers such as Syderoxidans, Gallionela and Thiobacillus.

### Example 2

### 56L Reactor Operation

### Materials and Methods

### 1. BES Design, Inoculation and System Operation

A 56 L reactor system (38 L cathode chambers and 18 L anode chambers) was constructed and deployed on-site next to swine farms and an aeration tank at Okinawa Livestock Research Center (FIG. 8 ~ 11). This system treats two different waste streams simultaneously, high organic raw wastewater, source of electron, in the anode chamber and low organic nitrate containing aerated wastewater in the cathode chamber (with low C/N ratio (~0.1)). The reactor comprised 2 anode chambers and 4 cathode chambers separated by the anion-exchange membrane (AMI-7001 Membrane Internationals) (FIGS. 8 -9). The same carbon brush electrodes were used from the Example 1 except for one-meter-long electrodes were installed in each chamber (FIGS. 9-11). The reactor allowed serpentine flow of the wastewater. Each chamber was inoculated with activated sludge taken from the aeration tank at 25% of the chamber volume. The cathodes were poised at -0.4 V vs Ag/AgCl using a potentiostat (Hokuto HA-151B).

Solid-separated raw swine wastewater collected from the farm was pumped into the Precipitation tank #1, where it was stored anaerobically for 3-5 hours. Thereafter it was transferred by another pump into the Precipitation tank #2, from which delivered into the anode chamber #1 in BES with 1 day HRT. After treatment in the anode chamber, the treated wastewater went in the aeration tank for oxidative treatment and nitrification. From the aeration tank the aerated wastewater was pumped into the Precipitation tank #3, where NO₃⁻ -N was adjusted to 300 mg L⁻¹ values. The aerated wastewater stored in the Precipitation tank #3 was pumped into the cathode chamber in BES for the final treatment with 2 days of HRT (FIG. 9), except for the retention time was changed at 4^{th} and 5^{th} months of operation to 1 day, then returned to 2 days HRT. The samples were taken before (inlet) and after (outlet) the treatment from both chambers.

### 2. Chemical Analysis

The concentrations of COD, ammonium (NH₄⁺-N), nitrate (NO₃⁻-N), nitrite (NO₂⁻-N) were analyzed using HACH test kits (USA). BOD, suspended solids, total nitrogen, soluble phosphorus, total phosphorus and calcium were analyzed according to the Environment Standards for water pollution method (Japan). Odor was measured by the odor sensor (XP-329IIIR, New Cosmos Electric Company, Japan).

### 3. Results

The results from the 56L reactor operation are shown in FIGS. 12-14. FIG. 14 indicates that the BES successfully removed BOD, COD SS and odor in the anode chamber, and NO₃⁻, total nitrogen, soluble P, total P and calcium in the cathode chamber. On average, approximately 1 g/L BOD was removed from the raw wastewater using the device. The removal of 1 g/L BOD was calculated to reduce 50% of operational costs and the cost saving is attributed mainly to a reduction in excess sludge removal and in electricity consumption, made possible by a shorter aeration time. This also leads to a reduction in CO₂ emission from the aeration tank.

### Example 3

### BES Operation With an External Resistor

Experiments were carried out using the same 2 L reactor described in Example 1 in a three-electrode setup applied cathodic potentials to -0.4 V as shown in FIG. 7i and a two-electrode setup for external resistor experiment (R=500Ω) as shown in FIG. 7ii. In the three-electrode setup, the cathode was used as a working electrode controlled chronoamperometrically and the Ag/AgCl electrode was used as a reference electrode (0.197 V vs. standard hydrogen electrode, Radiometer XR300 Reference Electrode, Hach). Cell voltage during the external resistor experiment was monitored with a data logger (GRAPHTEC Midi Logger GL240). All experiments were done with AEM as a separator and raw swine ww in the anode chamber and the aerated ww in the cathode chamber without nitrate adjustment which leads to varying nitrate concentration at the start of experiments. After inoculation, BESs were preincubated under open circuit potential (OCP) to allow a bacterial biofilm to acclimatize to the environment.

Nitrate removal during applied cathodic potential -0.4 V vs Ag/AgCl and using external resistor R=500Ω in 3 days experiment is compared in FIG. 7E. FIG. 7F shows cathode potential, anode potential and current during the external resistor experiment R=500Ω in time is shown. FIGS. 7E and 7F indicate that the BES successfully removed NO₃⁻ without electric power supply. This means that the BES can function as a battery.

### INDUSTRIAL APPLICABILITY

The biocathodic denitrifying BES in the present application is a promising technology for the treatment of two different types of swine wastewater: raw wastewater for organics, odors and pathogens removal and aerated wastewater for nitrate removal. Conditions when cathodes were poised to -0.6 V encouraged the growth of autotrophic denitrifying bacteria while simultaneously increasing the rate of nitrate removal. Electrotrophic Syderoxydans lithotrophicus and Gallionella capsiferriformans were the dominant species in short-term and Thiobacillus denitrificans in long-term operations.

The system may comprise a pre-treatment system (sequential precipitation tanks to remove large particles from wastewater), and subsequent wastewater flow into the BES bioreactor.

When cathodic wastewater contains phosphate and calcium, the cathode chamber also removes phosphate via electrocrystallization. In this case, phosphate salt precipitates, for example, calcium phosphate, on the cathode. In some embodiments, more than 30%, preferably more than 50%, of phosphate phosphorus present in the aerated wastewater is removed in terms of the amount by weight of phosphorus after treatment in the cathode chamber. The system was also proven to reduce fecal bacteria, using E. coli as an indicator.

The current system can work using swine wastewater which is one of the harshest wastewater. Being anaerobic treatment, there is almost no need for excess sludge removal which leads to operational cost reduction.

The device can allow utilization of chemical energy from raw wastewater having high COD in the anode chamber to reduce nitrate in the aerated wastewater in the cathode chamber. Electrons produced by oxidizing COD in an anaerobic condition are donated to the anode by electrogenic bacteria and through an external circuit, and the electrons flow to the cathode to be used by denitrifying bacteria, which reduce nitrate to N₂. This setup allows nitrate to be reduced even if the wastewater in the cathode is low in COD. The pH in the cathode chamber rises when nitrate is reduced to N₂ which leads to phosphate salt to be precipitated.

The advanced wastewater treatment described here can remove COD in raw wastewater in the anode chamber in the anaerobic condition and it generates much less excess sludge than conventional activated sludge processes. The device can be installed as an addition to an existing aeration wastewater facility, and this typically results in an increase in treatment capacity and a decrease in operational costs (FIG. 10.). In other words, the device of the present invention can denitrify aerated wastewater, which may be low in COD, using the energy harvested by treating raw wastewater, without a need to add further chemicals or adjust COD and oxygen levels for denitrification.

1. A device for simultaneously denitrifying aerated wastewater and treating raw wastewater, containing:
at least one anode chamber equipped inside with at least one anode, for treating raw wastewater and
at least one cathode chamber equipped inside with at least one cathode, for denitrifying aerated wastewater;
wherein the anode chamber is attached to the cathode chamber via separator in order to transport anions and/or cations between the anode chamber and the cathode chamber.

2. The device according to claim 1, wherein the cathode chamber and/or anode chamber further comprise inside a reference electrode.

3. The device according to claim 1, wherein the anode and/or cathode are conductive electrode.

4. The device according to claim 3 wherein the conductive electrode(s) comprise(s) carbon fibers or stainless steel.

5. The device according to claim 1, wherein at least one of the anode and cathode chambers containing a means for stirring inside the chamber continuously or periodically.

6. The device according to claim 1, wherein the device is to be connected to an aeration tank.

7. A system for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite; containing
1) the device according to claim 1, and
2) a means for adjusting the potential between the cathode and the anode or between the cathode or the anode versus the reference electrode,
wherein the means is connected to the anode and the cathode, or to the anode, the cathode and the reference electrode;
in the anode chamber, electrogenic bacteria degrade the organic compounds in the raw wastewater and provide electrons through the anode; and
in the cathode chamber, denitrifying bacteria receive the electrons via the cathode and reduce the nitrate and/or nitrite in the aerated wastewater to N₂ gas.

8. The system according to claim 7, wherein the means for adjusting the potential is a potentiostat or an external resistor or open circuit potential (OCP) mode.

9. The system according to claim 7, wherein the electrogenic bacteria comprise at least one kind of bacteria selected from the group of consisting of species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus, and Ralstonia.

10. The system according to claim 7, wherein the denitrifying bacteria comprise at least one kind of bacteria selected from the group of consisting of species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, and Maribacter.

11. A method for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite; by using a device containing
at least one anode chamber equipped inside with at least one anode, and
at least one cathode chamber equipped inside with at least one cathode,
wherein the anode chamber is attached to the cathode chamber via separator in order to transport anions and/or cations between the anode chamber and the cathode chamber, comprising
1) a step of adding the raw wastewater into the anode chamber and adding the aerated wastewater into the cathode chamber; and then
2) a step of adjusting the potential between the anode and the cathode,
wherein, in the anode chamber, electrogenic bacteria degrade the organic compounds and thereby provide electrons through the anode; and in the cathode chamber, denitrifying bacteria receive the electrons via the cathode and reduce the nitrate and/or nitrite to N₂ gas.

12. A method for simultaneously performing anaerobiotic elimination of organic compounds such as organics, suspended solids and volatile fatty acids, and pathogens from raw wastewater comprising the organic compounds, and removal of nitrate and/or nitrite from aerated wastewater comprising the nitrate and/or nitrite; by using a device containing
at least one anode chamber equipped inside with at least one anode,
at least one cathode chamber equipped inside with at least one cathode, and
a reference electrode in the cathode chamber or anode chamber
wherein the anode chamber is attached to the cathode chamber via separator in order to transport anions and/or cations between the anode chamber and the cathode chamber, comprising
1) a step of adding the raw wastewater into the anode chamber and adding the aerated wastewater into the cathode chamber; and then
2) a step of adjusting potential either to the cathode or the anode versus the reference electrode, wherein, in the anode chamber, electrogenic bacteria degrade the organic compounds and thereby provide electrons through the anode; and in the cathode chamber(s), denitrifying bacteria receive the electrons via the cathode and reduce the nitrate and/or nitrite to N₂ gas.

13. The method according to claim 11, wherein the electrogenic bacteria comprise at least one kind of bacteria selected from the group of consisting of species of Geobacter, Desulfovibrio, Syntrophobacter, Clostridium, Alicycliphilus, Thauera, Acidovorax, Xanthomonas, Bacteroides, Rhodopseudomonas, Thiomonas, Acinetobacter, Stenotrophomonas, Dechloromonas, Pseudomonas, Azoarcus, and Ralstonia.

14. The method according to claim 11, wherein the denitrifying bacteria comprise at least one kind of bacteria selected from the group of consisting of species of Syderoxidans, Gallionela,Thiobacillus, Thauera, Mycobacterium, Alicycliphilus Azoarcus, Acidovorax, Psudomonas, Dechloromonas, Methylibium, Burkholderia, Leptothrix, Ralstonia, Aromatoleum, Cupriavidus, Delfia, Nitrosomonas, Methylococcus, and Maribacter.

15. The method according to claim 11, wherein the raw wastewater is livestock wastewater or supernatant thereof.

16. The method according to claim 11, wherein the raw wastewater is swine wastewater or supernatant thereof.

17. The method according to claim 11, wherein the aerated wastewater is aerated livestock wastewater or supernatant thereof with low level of organic compounds.

18. The method according to claim 11, wherein the aerated wastewater is aerated swine wastewater or supernatant thereof with low level of organic compounds.

19. The method according to claim 12, wherein the potential is applied and adjusted to the cathode at -0.2 to -0.8 V vs the reference electrode (Ag/AgCl) at the step 2).

20. The method according to claim 12, wherein the potential is applied and adjusted to the cathode at -0.4 to-0.6 V vs the reference electrode (Ag/AgCl) at the step 2).

21. The method according to claim 11, further comprising,
0) a step of inoculating the anode chamber and/or the cathode chamber with activated sludge at an amount of 0% to 60% capacity thereof.

22. The method according to claim 21, wherein the step 0 is a step of inoculating the anode chamber and/or the cathode chamber with the activated sludge at an amount of 20% to 25% capacity thereof.

23. The method according to claim 11, wherein the aerated wastewater after the step 2 comprises total 100 mg/L or less of NO₃⁻ and NO₂⁻ as nitrogen equivalent.

24. A method for simultaneously performing
anaerobiotic elimination of organic compounds such as organics, suspended solids and volatile fatty acids, and pathogens from raw wastewater comprising electrogenic bacteria and the organic compounds, and
removal of nitrate and/or nitrite and phosphate from aerated wastewater comprising denitrifying bacteria and the nitrate and/or nitrite and phosphate;
by using a device containing
at least one anode chamber equipped inside with at least one anode, and
at least one cathode chamber equipped inside with at least one cathode,
wherein the anode chamber is attached to the cathode chamber via separator in order to transport anions and/or cations between the anode chamber and the cathode chamber, comprising
1) adding the raw wastewater into the anode chamber and adding the aerated waste water into the cathode chamber; and then
2) adjusting the potential between the anode and the cathode,
wherein, in the anode chamber, the electrogenic bacteria degrade the organic compounds and thereby provide electrons through the anode; and in the cathode chamber, the denitrifying bacteria receive the electrons via the cathode and reduce the nitrate and/or nitrite to N₂ gas insoluble in water, and salts of the phosphate are precipitated in the cathode chamber.

25. A method for simultaneously performing
anaerobiotic elimination of organic compounds such as organics, suspended solids and volatile fatty acids, and pathogens from raw wastewater comprising electrogenic bacteria and the organic compounds, and
removal of nitrate and/or nitrite from aerated wastewater comprising denitrifying bacteria and the nitrate and/or nitrite;
by using a device containing
at least one anode chamber equipped inside with at least one anode,
at least one cathode chamber equipped inside with at least one cathode, and
a reference electrode in the cathode chamber or anode chamber
wherein the anode chamber is attached to the cathode chamber via separator in order to transport anions and/or cations between the anode chamber and the cathode chamber, comprising
1) adding the raw wastewater into the anode chamber and adding the aerated waste water into the cathode chamber; and then
2) adjusting potential either to the cathode or the anode versus the reference electrode,
wherein, in the anode chamber, the electrogenic bacteria degrade the organic compounds and thereby provide electrons through the anode; and in the cathode chamber, the denitrifying bacteria receive the electrons via the cathode and reduce the nitrate and/or nitrite to N₂ gas insoluble in water, and salts of the phosphate are precipitated in the cathode chamber.

26. The method according to claim 24, wherein more than 30% of phosphate phosphorus present in the aerated wastewater is removed by step 2) in terms of the amount by weight of phosphorus.
